(19) United States
(12) Patent Application Publication
(10) Pub. No.: US 2016/0203443 A1
(43) Pub. Date: Jul. 14, 2016

(54) METHOD AND SYSTEM FOR INSURANCE CLAIMS ADJUSTMENT SCHEDULING

(71) Applicant: Rebecca Wheeling, Elizabethtown, KY (US)

(72) Inventor: Rebecca Wheeling, Elizabethtown, KY (US)

(21) Appl. No.: 14/595,143

(22) Filed: Jan. 12, 2015

(51) Int. Cl. G06Q 10/10

(52) U.S. Cl. CPC G06Q 10/1095; G06Q 40/08

(57) ABSTRACT

The invention relates to a system and method that allows for the insurance adjuster to manage, schedule, route, track income, and track expenses for multiple insurance companies or multiple independent adjusting firms handling claims for multiple insurance companies. More specifically, a scheduler uses a specialized interface to manage insurance companies, insurance adjustment firms, adjusters, schedulers, homeowners, and scheduled appointments. An administrator may oversee the entire system, and a plurality of schedulers may utilize the same system to manage and schedule appointments for many independent insurance claims adjusters investigating claims for different insurance companies. The invention automates and streamlines the claims adjustment scheduling process and provides the user with an all in one solution for scheduling insurance claims adjustment appointments.

### FIELD OF THE INVENTION

The invention generally relates to the field of insurance claims adjustment. More specifically, the invention relates to the field of insurance adjusters managing insurance claims adjustment appointments, income tracking, and expense tracking.

### BACKGROUND OF THE INVENTION

The current insurance claims adjustment process is a time and labor intensive process that requires great attention to detail. The portion of the claims adjustment process done at the site of the damage or loss is done by a claims adjuster. Claims adjusters are those responsible for investigating claims, evaluating whether coverage exists for submitted claims, determining who is liable or the cause of damage or injury associated with a claim, and for determining scope of damage or injury related to a claim. An adjuster can be an employee of the insurer, an employee of an independent adjusting firm or an independent adjuster retained either on a contract basis or on an individual adjustment basis. Adjusters are usually employed as field adjusters who operate outside the claims office or as inside adjusters who adjust claims from within the claims office. Field adjusters spend much of their time visiting the scene of a loss, interviewing witnesses and investigating damages. Due to the fact that most claims adjusters are required to spend a good deal of time away from the claims office in processing claims, it would be advantageous to reduce the number of trips the claims adjuster needs to make to the property to finish an estimate and close a claim.

There are several major steps involved in claims processing. The claims adjustment process begins after an insured claimant's property is damaged. The claimant contacts his or her insurance company to report the damage to the insured property. The insurance company will verify the insurance coverage, create a claim file, and assign the claim to an insurance claims adjuster. After coverage has been verified, the file has been created, and once a claims adjuster has been assigned she will schedule and document an appointment to travel to the property to perform an assessment of the damage and create an estimate of the cost of the repairs.

Claims adjusting is the process of evaluating the reported damage to property and then determining what the fair settlement amount for the damage will be and reporting that amount in the form of an estimate. The field adjuster's job is to tell the story of what occurred during this loss to whoever may be reviewing it at the insurance company. The claims adjuster will investigate the facts related to the claim and will negotiate the cost of materials and services required to repair the damaged property and fulfill the claim. The claims adjuster will utilize different sources of information in the claims adjustment process including interviews with the claimant and other witnesses, photographs of the property, databases of cost estimates, databases of parts and components, prior claim files, and the claimant's insurance information.

The scheduling of the claims adjusters is a time and labor intensive process, and the inventor is not aware of any effective solution for managing claims adjusters who are handling claims for different independent Adjusting Firms or Insurance Companies. The inventor is not aware of any effective existing system or process for routing the claims in the field and for managing appointments with multiple insurance policyholders—insureds. Furthermore, the inventor is not aware of any effective system for generating reports relating to the claims scheduling process that are standardized for use with multiple insurance companies and IA firms.

Existing solutions for managing claims, or scheduling claims, or managing appointments include Xactware Xactanalysis, OnlineReporting, Inc. FileTrac, ClaimStream, iFleet, and QuickBooks SmartService. However, none of these existing solutions provide for the ability to consider each adjusters personal preferences for routing, time to inspect losses, or drive time based on location of inspections.

What is needed is a system that allows for the management and routing of multiple schedulers, insurance adjusters, insurance companies, insureds, and appointments that also allows for the documentation of sufficient detail to fully describe the nature of the appointment to the insurance claims adjuster. What is also need is a system that provides foreach insurance adjuster to manage insurance claims from multiple independent insurance companies or independent adjusting firms with multiple insurance companies, apply routing parameters based on the adjusters personal preferences, connect the routed claims to the adjusters personal calendar, and allow input of claim data that is based on the different claim types to ensure the adjuster is knowledgeable and prepared to complete the inspection at the scheduled time/date.

### SUMMARY OF THE INVENTION

The present invention provides a method and a system that allows for the insurance adjuster to manage, schedule, route, track income, and track expenses for multiple insurance companies or multiple independent adjusting firms handling claims for multiple insurance companies, the assigning of schedulers for different claims adjusters and management of said schedulers, and allows both schedulers and adjusters report capabilities of all claims data.

The present invention provides a web-based scheduling and management solution. The system of the present invention provides for the management of both schedulers and adjusters and for the scheduling of insurance claims adjustment appointments. The present system also generates reports relating to claims adjustment reports, income tracking for the claims adjustments, and daily expense tracking.

In one embodiment, the present invention provides a method for scheduling and managing insurance loss events, the method comprising: creating a first entity and a second entity; associating the first entity to the second entity; associating a set of scheduling rules with the second entity; generating an appointment comprising a set of appointment information and a set of claim information, and associating the appointment, the set of appointment information, and the set of claim information with a third entity; associating the appointment with the second entity; automatically generating by a computer a set of scheduling and routing information, the set of scheduling and routing information based on the set of scheduling rules associated with the second entity and the appointment information and associating the set of scheduling and routing information with the appointment; displaying the appointment on a display associated with the first entity or the second entity.

The embodiment of the method may further comprise wherein the set of scheduling rules comprise appointment duration, number of appointments per day, distance to begin, start date, average drive time, window for appointment time, and appointment start time. The program takes this information and applies it to the claims that are not confirmed on the adjuster's individual calendar. The claims are placed onto the calendar after these rules are applied (automatically) and the route on the map is synchronized to the calendar. Any time a claim moves on the calendar it is automatically moved on the route map. The appointment may be displayed on a map and on a calendar. The method may further comprise generating a set of billing information associated with the appointment. The appointment information may comprise information selected from the group consisting of claim type, IA firm, insurance company information, house information, damage information, mortgage company information, and scheduling availability information. The claim type may be selected from the group consisting of hail, wind, tornado, fire, smoke, water, freeze, flood, commercial, hurricane, and additional other claim types. The method may further comprise wherein the appointment is associated with the second entity by the first entity. The method may further comprise updating the set of appointment information and the set of claim information.

In another embodiment, the present invention provides a system for scheduling and managing insurance loss events, the system comprising: an appointment database and an entity database; a server, the server comprising a processor and memory, the memory adapted to store a set of instruction for execution by the processor, the instructions adapted to: receive a first set of information associated with a first entity and a second set of information associated with a second entity; generate a first entity record based on the first set of information and associated with the first entity and a generate a second entity record based on the second set of information and associated with the second entity; store the first entity record and second entity record in the entity database; associate the first entity record with the second entity record; associate a set of rules with the second entity; generate an appointment record comprising a set of appointment information and a set of claim information, and associating the appointment record, the set of appointment information, and the set of claim information with a third entity record associated with a third entity; store the appointment record in the appointment database and the third entity record in the entity database; automatically generate a set of scheduling and routing information, the set of scheduling and routing information based on the set of scheduling rules associated with the second entity and the appointment information, and associate the set of scheduling and routing information with the appointment record; store the set of scheduling and routing information in the appointment database; and display the set of scheduling and routing information.

The system may further comprise wherein the set of scheduling rules comprise distance to begin, start date, average drive time, window for appointment, appointment duration, number of appointments per day, and appointment start time. The instructions may further be adapted to display the appointment record on a map and on a calendar. The instructions may further be adapted to generate a set of billing information associated with the appointment. The appointment information may comprise information selected from the group consisting of claim type, IA firm, insurance company information, house information, damage information, mortgage company information, and scheduling availability information. The claim type may be selected from the group consisting of hail, wind, tornado, fire, smoke, water, freeze, flood, commercial, hurricane, and additional other claim types. The instructions may further be adapted to update the set of appointment information and the set of claim information.

In another embodiment, the present invention comprises a method for scheduling and managing insurance loss events, the method comprising: creating a first entity and a second entity; associating the first entity to the second entity; associating a set of scheduling rules with the second entity; generating an appointment comprising a set of appointment information and a set of claim information, and associating the appointment, the set of appointment information, and the set of claim information with a third entity; associating the appointment with the second entity; automatically generating by a computer a set of scheduling information, the set of scheduling information based on the set of scheduling rules associated with the second entity and the appointment information and associating the set of scheduling information with the appointment; generating a second appointment comprising a second set of appointment information and a second set of claim information, and associating the second appointment, the second set of appointment information, and the second set of claim information with a fourth entity; associating the appointment with the second entity; automatically generating by a computer a second set of scheduling information, the second set of scheduling information based on the set of scheduling rules associated with the second entity and the appointment information and associating the second set of scheduling information with the second appointment; wherein the automatically generating by a computer a set of routing information comprises generating the set of routing information based on the set of scheduling information, the second set of scheduling information, and a set of routing preferences; and displaying the appointment and second appointment on a display associated with the first entity or the second entity.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a representative network diagram of the components involved in a first embodiment of the invention.

FIG. 2 is a flowchart of the elements of the scheduling and management system according to the present invention.

FIG. 3 is a screenshot of an embodiment of an administrator dashboard that allows for access to different areas of the console.

FIG. 4 is a screenshot of an embodiment of the change password interface.

FIG. 5 is a screenshot of an embodiment of a create scheduler interface.

FIG. 6 is a screenshot of an embodiment of a create adjuster interface.

FIG. 7 is a screenshot of an embodiment of an add IA firm interface.

FIG. 8 is a screenshot of an embodiment of an add insurance company interface.

FIG. 9 is a screenshot of an embodiment of a list IA firms interface.

FIG. 10 is a screenshot of an embodiment of an insurance companies listing interface.

FIG. 11 is a screenshot of an embodiment of a schedulers listing interface.

FIG. 12 is a screenshot of an embodiment of an adjusters listing interface.

FIG. 13 is a screenshot of an embodiment of a login interface.

FIG. 14 is a screenshot of an embodiment of a forgot password interface.

FIG. 15 is a screenshot of an embodiment of a scheduler dashboard that allows for access to different areas of the console.

FIG. 16 is a screenshot of an embodiment of adding a new claim to the system.

FIG. 17 is a screenshot of an embodiment of a claim details information interface.

FIG. 18 is a screenshot of an embodiment of an appointments listing interface.

FIG. 19 is a screenshot of an embodiment of a route and calendar interface.

FIG. 20 is an embodiment of an appointment report generating according to the present invention.

FIG. 21 is a screenshot of an embodiment of a report management interface according to the present invention.

FIG. 22 is a screenshot of an embodiment of a report creation interface according to the present invention.

FIG. 23 is a screenshot of an embodiment of a report creation interface according to the present invention.

FIGS. 24-32 are embodiments of reports generated according to the present invention.

FIG. 33 provides a screenshot of an expense interface according to the present invention.

FIGS. 34-42 provide screenshots of an embodiment of aspects of an administrator interface according to the present invention.

FIGS. 43-46 provide screenshots of an embodiment of a scheduler or self-scheduling adjuster interface according to the present invention.

FIGS. 47-51 provide screenshots of an embodiment of an appointment editing interface according to the present invention.

FIG. 52 is a flowchart of the elements of the scheduling and management system according to the present invention.

### DETAILED DESCRIPTION OF THE INVENTION

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

The present invention provides for an insurance claims adjustment appointment scheduling and management system that enables administrators, schedulers, and adjusters to interact and exchange information through a central information portal and utility. Individual businesses that use the system and method of the present invention may be provided with their own scheduling interface or may choose to be managed by another administrator or scheduler through a common interface. The system of the present invention provides for the management of the individuals with access to the system as well as of insurance claims adjustment appointments. The system provides access to billing and scheduling information, and also generates and provides reports related to billing and scheduling events. Furthermore, the scheduling and management system provides for the calendar to the synchronized with the routing of insurance claims Assigned to an individual insurance adjuster. This allows the adjuster to save time traveling between appointments, manually routing the route for his daily claim appointment inspections, and manually using two different programs to complete this currently.

The system can generate reports that provide a summary of each individual appointment as scheduled including the most pertinent to assist the insurance adjuster. The reports may also contain summaries of information from the insured or from the schedulers that may comprise time and date stamps for all activities performed related to a particular insurance claim.

The system also centrally manages billing for all claims scheduled for the claims adjusters. Billing is applied according to each individual insurance adjuster's needs. Billing is managed through the scheduling and management system of the present invention.

The scheduling and management system of the present invention may also import various types of external documents to be included in the reports generated by the system. The documents may include data collected about an insurance claim, data about an insured, documents including photographs collected at a claims site, and external billing data.

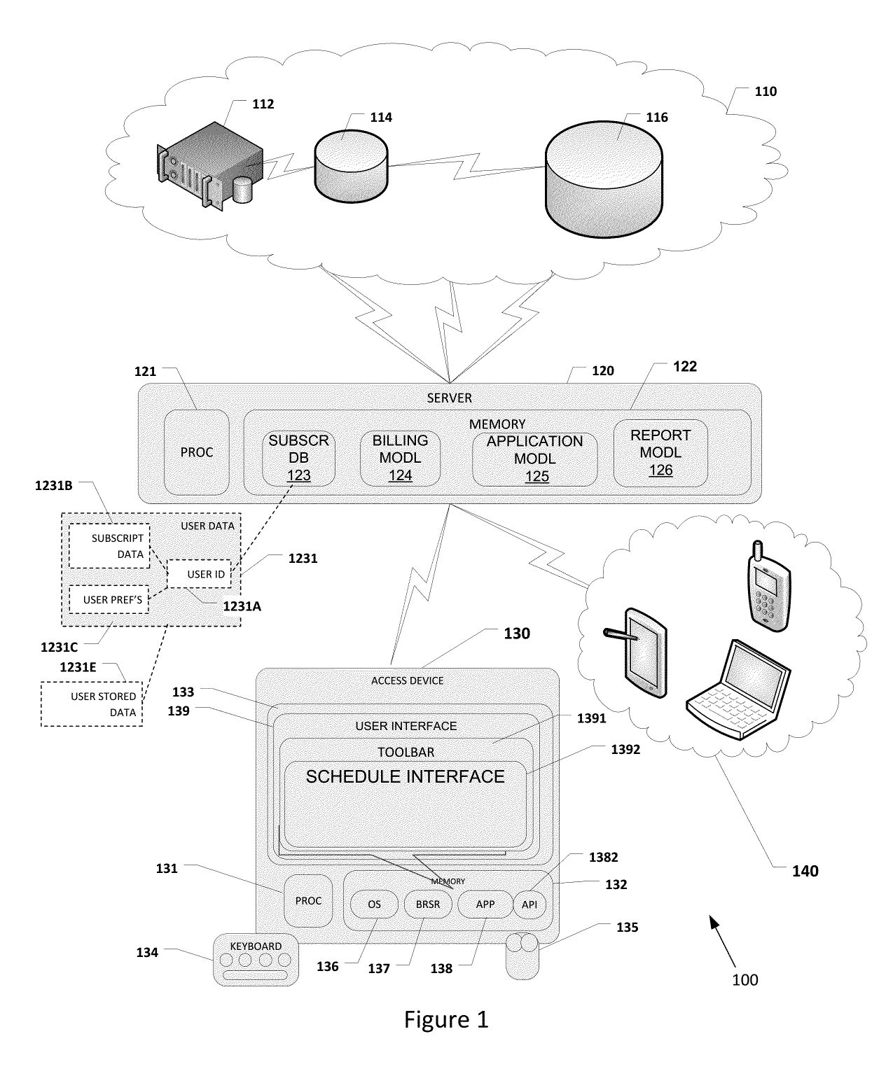

With reference now to FIG. 1, an exemplary insurance adjustment scheduling system 100 is adapted to integrate with either or both of a central server or a client-operated processing system as depicted. System 100 includes one or more databases 110, one or more servers 120, one or more access (e.g., client) devices 130, and one or more mobile client devices 140.

In one implementation, the present invention is provided as a web-based software-as-a-service system wherein the system may be accessed via a network by the client access devices 130 and mobile devices 140. As illustrated in FIG. 1, the insurance adjustment scheduling system 100 includes database 110, server 120 and user interface 139 operating on access device 130. The user interface 139 is preferably a web browser such as Microsoft Internet Explorer®, an independent application running on the access device 130, or a mobile “app” running on one of the mobile devices 140. In this embodiment, the present invention provides for the scheduling of insurance claims adjustment appointments stored in the appointments database 114 for entities stored in the entity database 116. The databases 114 and 116 may be stored on the database server 112.

Database 110 includes an appointments database 114 and may also comprise additional databases (not shown) which may comprise a combination of internal, external, and/or third-party databases. The database server 112 may also include additional databases relating to subscriber information, mapping information, insurance company information, insurance claims information, IA firm information, and insurance adjuster information. The other databases may be accessible for use by system 100 to manage and schedule insurance adjustment appointments.

Databases 110, which take the exemplary form of one or more electronic, magnetic, or optical data-storage devices, include or are otherwise associated with respective indices (not shown). Each of the indices includes terms and phrases in association with corresponding document addresses, identifiers, and other conventional information. Databases 110 are coupled or couplable via a wireless or wireline communications network, such as a local-, wide-, private-, or virtual-private network, to server 120.

Server 120, which is generally representative of one or more servers for providing insurance adjustment appointment scheduling and management functionality through one or more service modules to clients of various “thicknesses.” More particularly, server 120 includes a processor module 121, a memory module 122, a subscriber database 123, a billing management module 124, an application module 125, and a reports module 126. Processor module 121 includes one or more local or distributed processors, controllers, or virtual machines. Memory module 122, which takes the exemplary form of one or more non-transitory electronic, magnetic, or optical data-storage devices, stores a subscriber database 123, which may be loaded from an external database such as entities database 116, a billing management module 124, an application module 125, and a reports module 126. The billing management module 124 comprises a set of commands and functions for managing billing information received, generated, and processed by the system. The billing management module 124 may generate billing reports and may receive and process external billing documents. The billing management module 124 may also generate billing documents to be exported and processed by external billing systems. The application module 125 comprises a set of commands and functions that implement scheduling and management software which may be stored locally in the server 120 or may be loaded from the database server 112. The reports module 126 comprises a set of commands and functions that implement report generation and management functionality. Reports generated and managed by the reports generation module include scheduling reports, billing reports, claims received reports, and insured information sheets.

Subscriber database 123 is an optional component of the sever 120 and may include subscriber-related data for controlling, administering, and managing membership or subscription-based access of databases 110. In the exemplary embodiment, subscriber database 123a includes one or more user preference (or more generally user) data structures. In the exemplary embodiment, one or more aspects of the user data structure relate to user customization of various search and interface options stored as user stored data 1231. User data 1231 also includes user ID 1231A, subscription data 1231B, user preferences 1231C, and external user stored data 1231E. Primary assets module 124a includes one or more search engines and related user-interface components, for receiving and processing user queries against one or more of databases 110.

Still with reference to FIG. 1, access device 130, such as a client device, is generally representative of one or more access devices. In the exemplary embodiment, access device 130 takes the form of a personal computer, workstation, personal digital assistant, mobile telephone, or any other device capable of providing an effective user interface with a server or database. Specifically, access device 130 includes a processor module 131, a memory 132, a display 133, a keyboard 134, and a graphical pointer or selector 135. In the exemplary embodiment, processor module 131 takes any convenient or desirable form and includes one or more processors, processing circuits, or controllers. Coupled to processor module 131 is memory 132. Memory 132 stores code (machine-readable or executable instructions) for an operating system 136, a browser 137, and scheduling and management software 138. In the exemplary embodiment, operating system 136 takes the form of a version of the Microsoft Windows operating system, and browser 137 takes the form of a version of Microsoft Internet Explorer. Operating system 136 and browser 137 not only receive inputs from keyboard 134 and selector 135, but also support rendering of graphical user interfaces on display 133. In some embodiments, display 133 may be a touch-screen display and may also serve to receive user inputs. Upon executing scheduling and management software 138 by processor 131, a scheduling and management interface 1392 integrated into the graphical-user interface 139 of the scheduling and management software 138 is defined in memory 132 and rendered or presented on display 133. Upon rendering, interface 139 presents data in association with one or more interactive control features (or user-interface elements) which is stored in memory as API 1382. The scheduling and management interface 1392 may also be loaded into the user interface 139 of the browser 137.

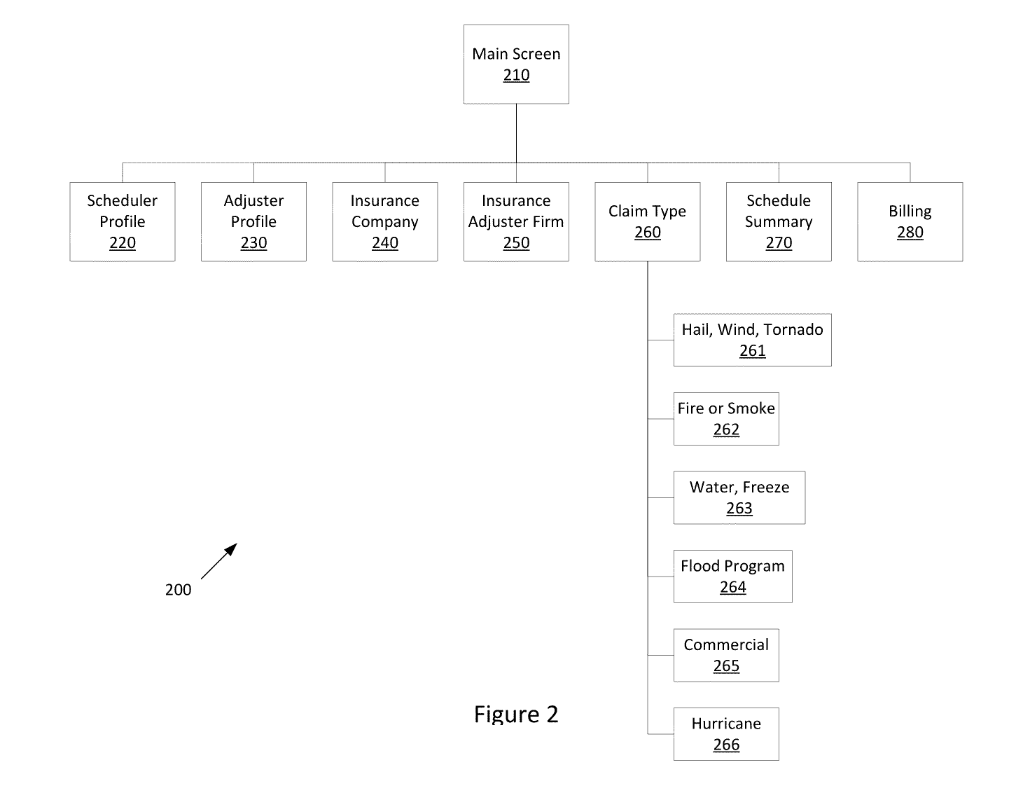

With reference now to FIG. 2, a flowchart 200 of the elements of the scheduling and management administration system according to the present invention. The system in the flowchart 200 may be accessed through a main or portal screen 210 that provides access to the other modules and functions of the system. The modules may include a scheduler profile module 220, an adjuster profile module 230, insurance company module 240, insurance adjuster firm module 250, claim type module 260, schedule summary module 270, and billing module 280. The claim type module 260 also provides access to the various types of insurance claim type modules including hail, wind, and tornado module 261, fire or smoke module 262, water or freeze module 263, flood program module 264, commercial module 265, and hurricane module 266. Each of the modules in the claim type module 260 comprise a specific set of information and tools related to the type of damage associated with the module. The specific tools sets include information for investigating the specific claim types, coverage information, safety information, and qualification requirements. Each of the modules that may be accessed from the main screen 210 may also be accessed through different portals available through the main screen 210. For example, the main screen 210 may be different for each of an administrative user, a scheduler, an adjuster, and a self-scheduling adjuster. These four user types may have different access to the system and may only be able to utilize certain aspects or functionality provided by the system depending on the user type. An administrator will have the broadest access, and a scheduler will have access to more features than an adjuster. A self-scheduling adjuster will have access to some scheduling and other features not available to an adjuster managed by a scheduler. The type of user accessing the main screen 210 will determine which of the modules are available to the user.

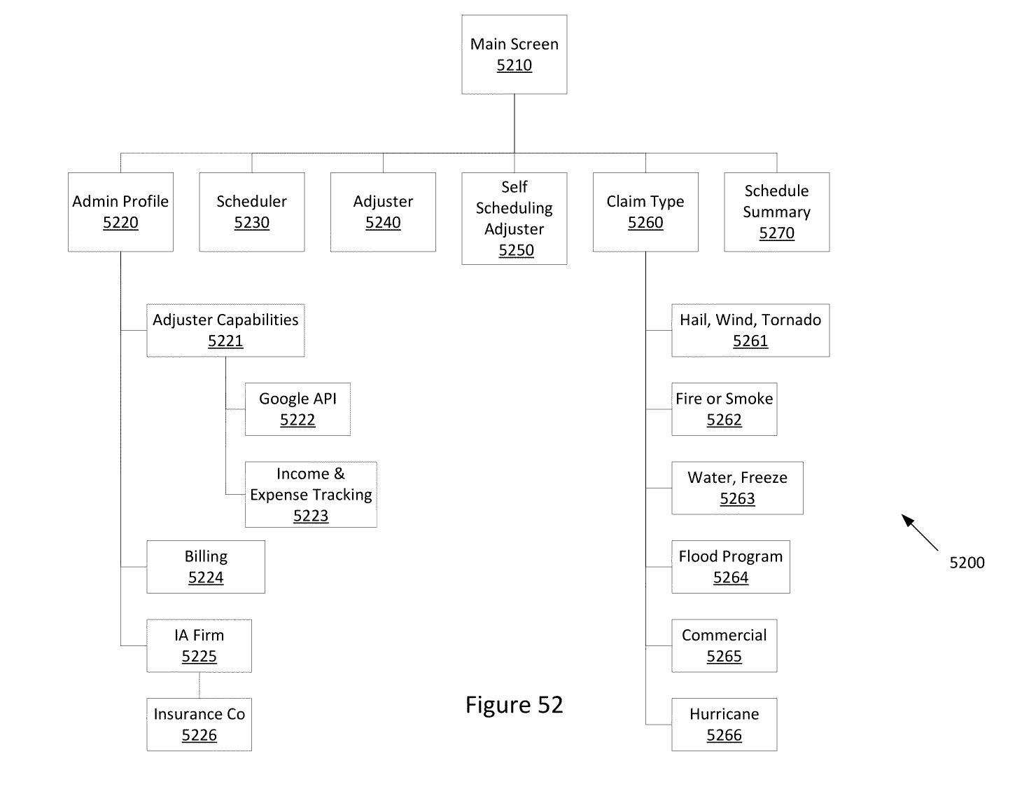

With reference now to FIG. 52, a flowchart 5200 of the elements of the scheduling and management administration system according to the present invention. The system in the flowchart 5200 may be accessed through a main or portal screen 5210 that provides access to the other modules and functions of the system. The modules may include an admin profile module 5220, a scheduler module 5230, adjuster module 5240, self-scheduling adjuster module 5250, claim type module 5260, and schedule summary module 5270. The claim type module 5260 also provides access to the various types of insurance claim type modules including hail, wind, and tornado module 5261, fire or smoke module 5262, water or freeze module 5263, flood program module 5264, commercial module 5265, and hurricane module 5266. From the admin profile module 5220 the adjuster capabilities module 5221, billing module 5224, and IA firm module 5225 modules may be accessed. The adjuster capabilities module 5221 may provide access to the Google API module 5222 and income & expense tracking module 5223. The IA firm module 5226 may provide access to the insurance company module 5226. Each of the modules in the claim type module 5260 comprise a specific set of information and tools related to the type of damage associated with the module. The specific tools sets include information for investigating the specific claim types, coverage information, safety information, and qualification requirements. Each of the modules that may be accessed from the main screen 5210 may also be accessed through different portals available through the main screen 5210. For example, the main screen 5210 may be different for each of an administrative user, a scheduler, an adjuster, and a self-scheduling adjuster. These four user types may have different access to the system and may only be able to utilize certain aspects or functionality provided by the system depending on the user type. An administrator will have the broadest access, and a scheduler will have access to more features than an adjuster. A self-scheduling adjuster will have access to some scheduling and other features not available to an adjuster managed by a scheduler. The type of user accessing the main screen 5210 will determine which of the modules are available to the user.

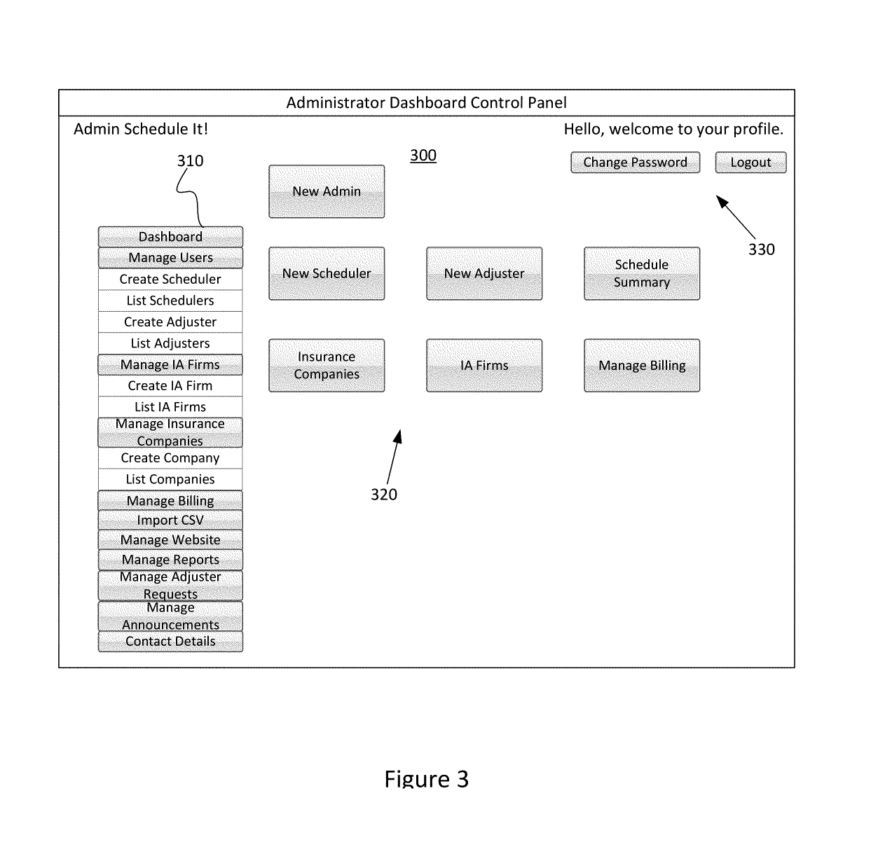

With reference now to FIG. 3, a screenshot of an embodiment of an administrator dashboard 300 according to the present invention is provided. The dashboard 300 provides a scheduling and management system administrator with access to the functions associated with the administrator. The administrator may access some features of the system not available to schedulers or adjusters. The administrator can use the dashboard sidebar 310 to manage users, manage IA firms, manage insurance companies, manage billing, import CSV, manage website, manage reports, manage adjuster requests, manage announcements, and contact details. The quick buttons 320 provide immediate access to features including adding a new scheduler to the system, adding a new adjuster to the system, adding a new administrator to the system, viewing a schedule summary, viewing a list of insurance companies, viewing a list of IA firms, and managing billing. An administrator may also change their password or logout of the system using the account profile buttons 330.

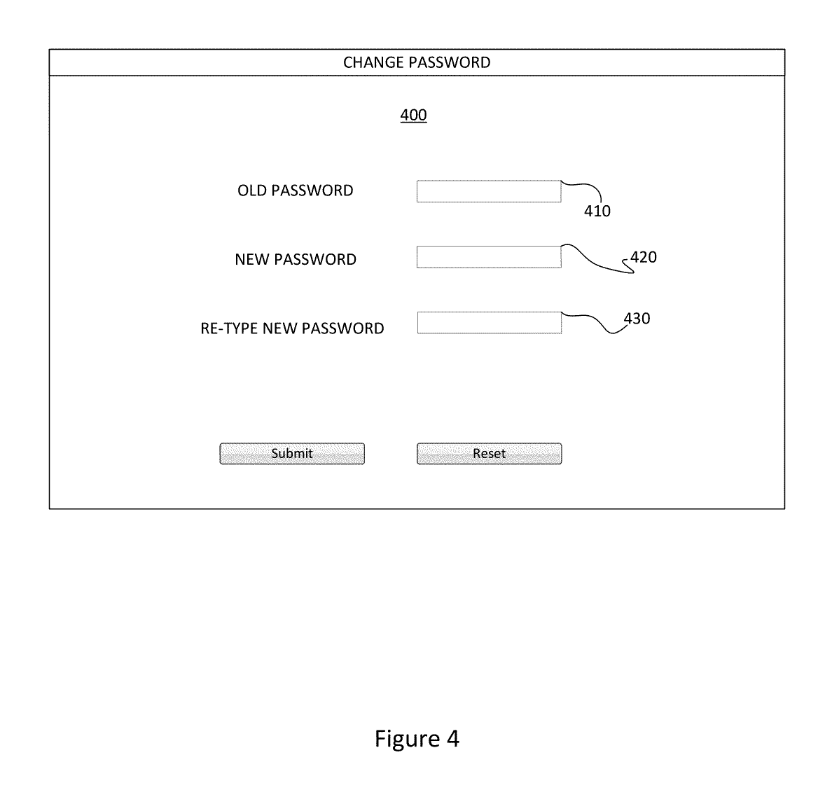

If the administrator, or any other user, wishes to change their password, they may do so using the change password interface 400 as shown in FIG. 4. To change a password using the change password interface 400, the user types in the old password in field 410, the new password in field 420, and then types the new password again in field 430. The user may submit the new password or reset the form.

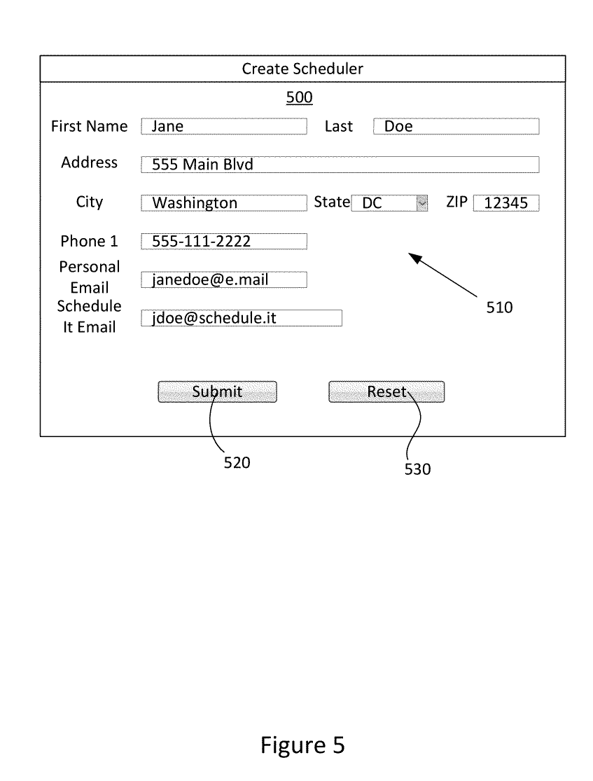

With reference now to FIG. 5, a screenshot of an embodiment of a create scheduler interface 500 according to the present invention is provided. The create scheduler interface 500 allows an administrator to add a new scheduler to the scheduling and management system 100. The administrator will add personal information about the new scheduler in the personal information fields 510 including first and last name, address, city, state, zip code, phone number, personal email, and scheduling and management system email. The scheduling and management system email is an email address reserved exclusively for use by the scheduling and management system 100. The scheduling and management system 100 will send emails to the user relating to any notifications for that user including new appointments, questions, requests, problems, or other system related communication.

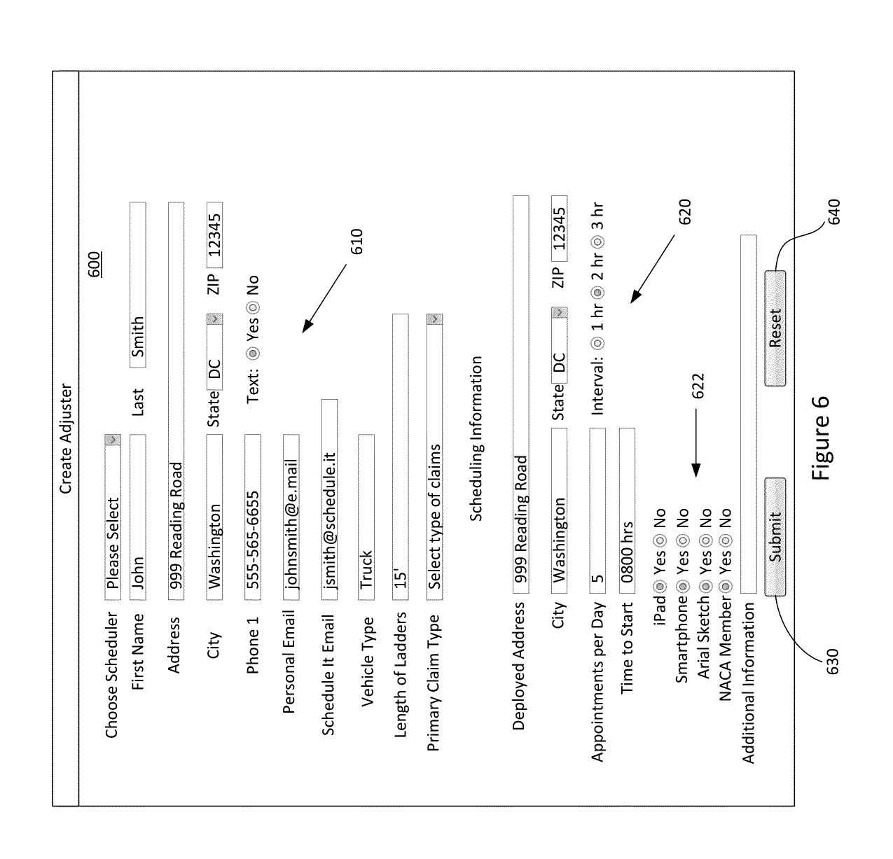

With reference now to FIG. 6, a screenshot of an embodiment of a create adjuster interface 600 according to the present invention is provided. The create adjuster interface 600 allows an administrator to add an adjuster to the system. The adjuster's personal information is entered in the personal information fields 610 and may include first and last name, address, city, state, and zip code, phone number, if texts are available, personal email, Schedule It email, vehicle type, length of ladders, and primary claim type. Information relating to how the adjuster can be scheduled is entered in the scheduling information fields 620 and may include deployed address, city, state, and zip code, number of appointments per day, appointment interval, and time first appointment may be scheduled. In the additional information fields 622, information such as the availability of an iPad, smartphone, aerial sketching, and NACA (Neighborhood Assistance Corporation of America) membership information may be indicated. The fields 620 and 622 may also be included on a scheduler's manage adjustor page instead of on the create adjuster interface 600. A new adjuster may be added by selecting the submit button 630 or the form may be reset using the reset button 640.

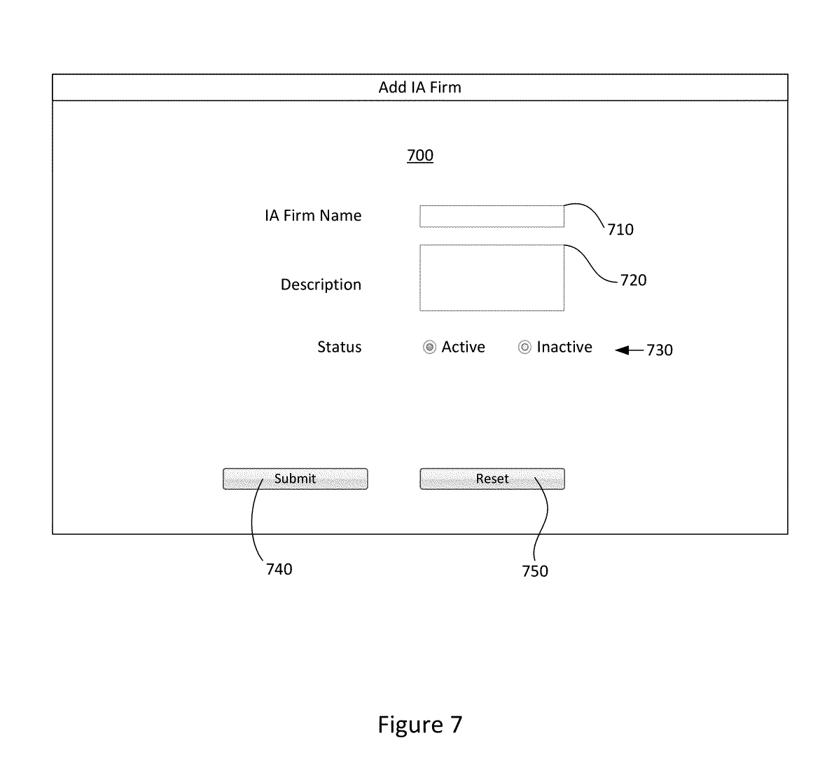

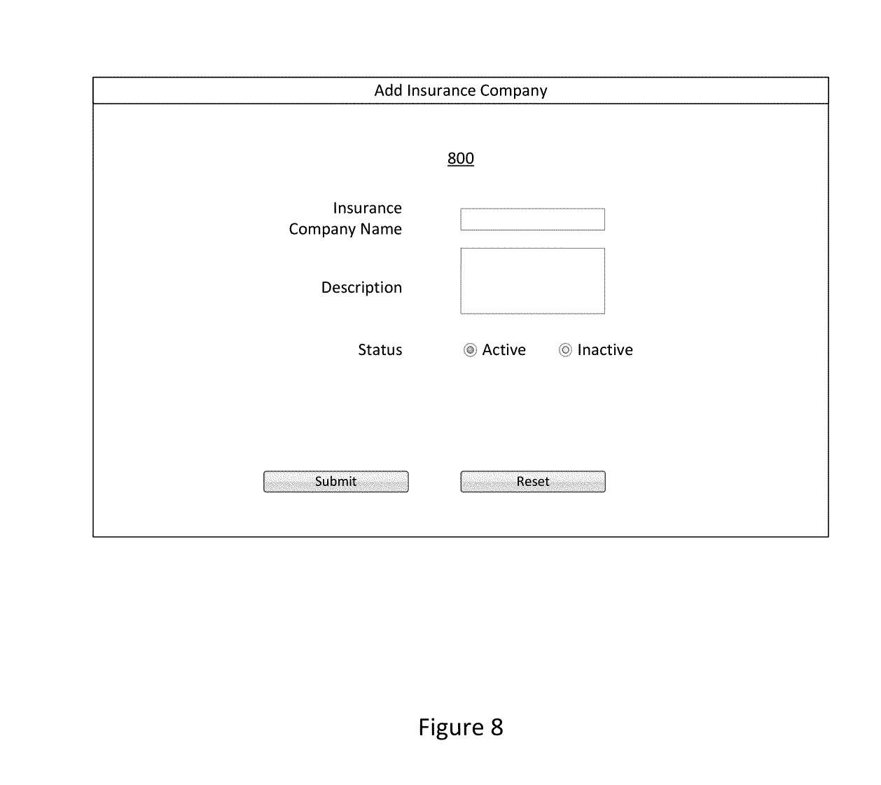

With reference now to FIGS. 7 and 8, screenshots of embodiments of an add IA firm interface 700 and add insurance company interface 800 according to the present invention are provided. The add IA firm interface 700 allows an administrator to add a new IA firm to the system. The new IA firm's name is entered in field 710, a description of the firm may be added in field 720, and the status of the firm is indicated using the radio buttons 730. The information may be submitted using submit button 740 or the data may be reset using reset button 750. A new insurance company may be added in a similar manner to a new IA firm using the add insurance company interface 800. Both insurance company and IA firm information may be edited using these interfaces.

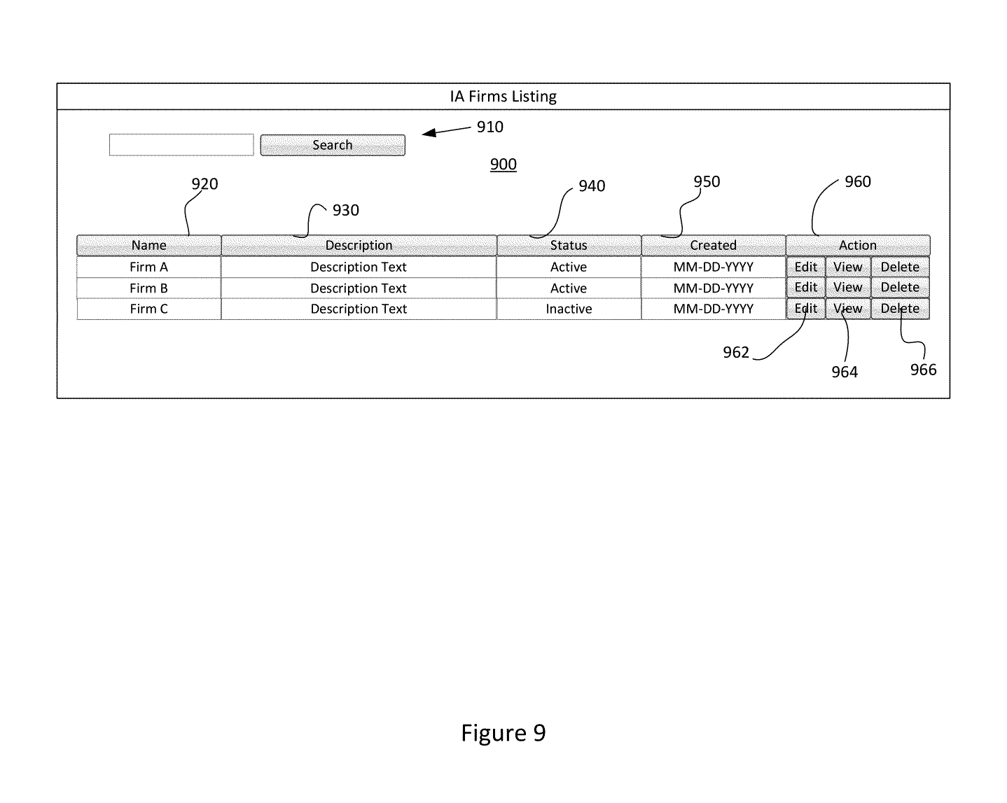

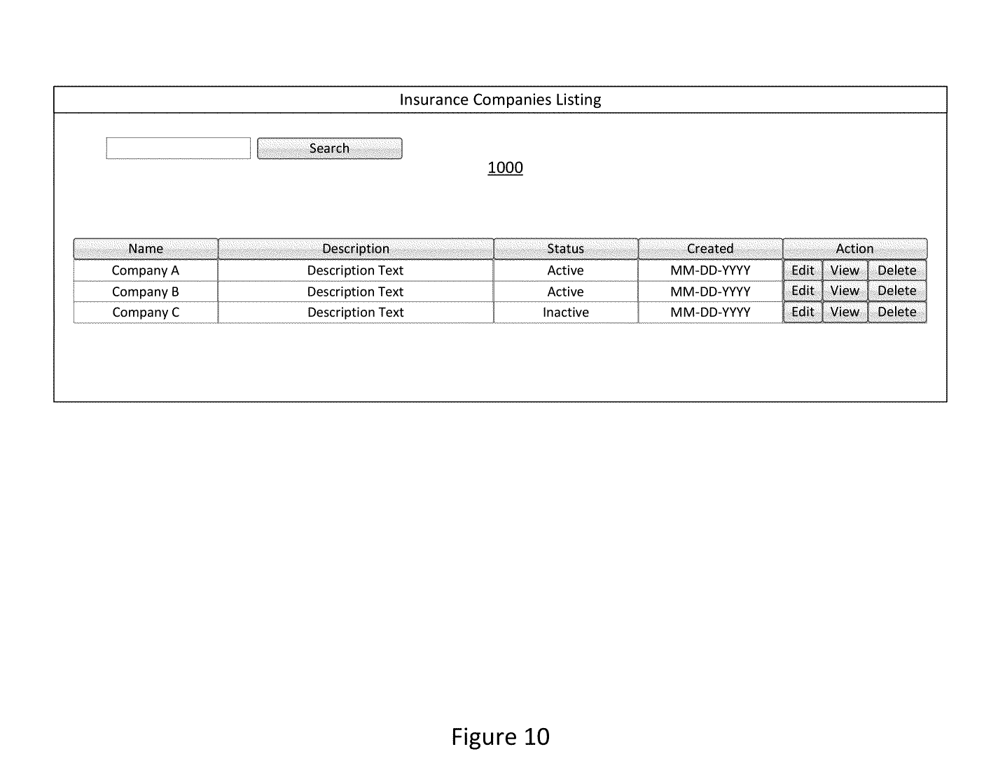

With reference now to FIGS. 9 and 10, screenshots of embodiments of an IA firms listing interface 900 and insurance company listing interface 1000 according to the present invention are provided. In the IA firms listing interface 900, all IA firms currently in the system are shown to the user. The name field 920 displays the name of each IA firm, the description field 930 displays a brief description of each firm, the status field 940 indicates the status of each IA firm, and the created field 950 indicates when each IA firm was created or added to the system. The action field 960 comprises a set of action buttons including edit button 962, view button 964, and delete button 966. The edit button 962 allows a user to edit an IA firm using the interface shown in FIG. 7. The view button 964 allows a user to view the details of a specific IA firm. A firm may be deleted from the system using the delete button 966. A user may also search for a specific IA firm using the search function 910. Insurance companies are displayed and may be managed in the same manner using the insurance company listing interface 1000.

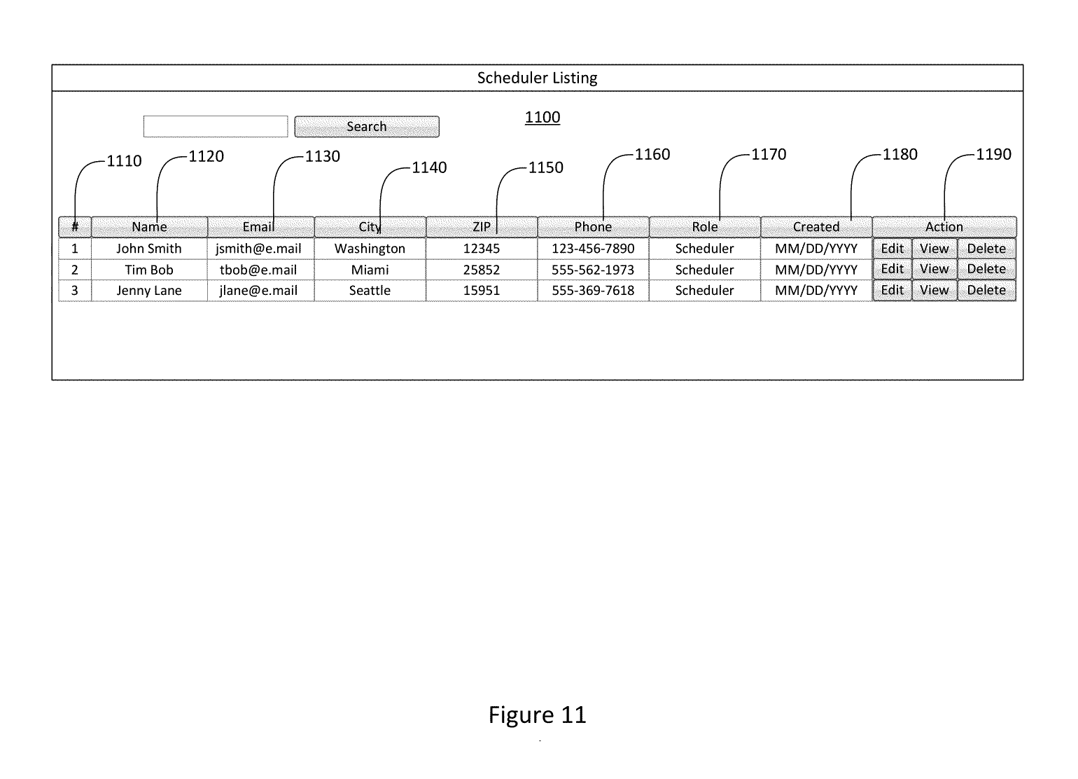

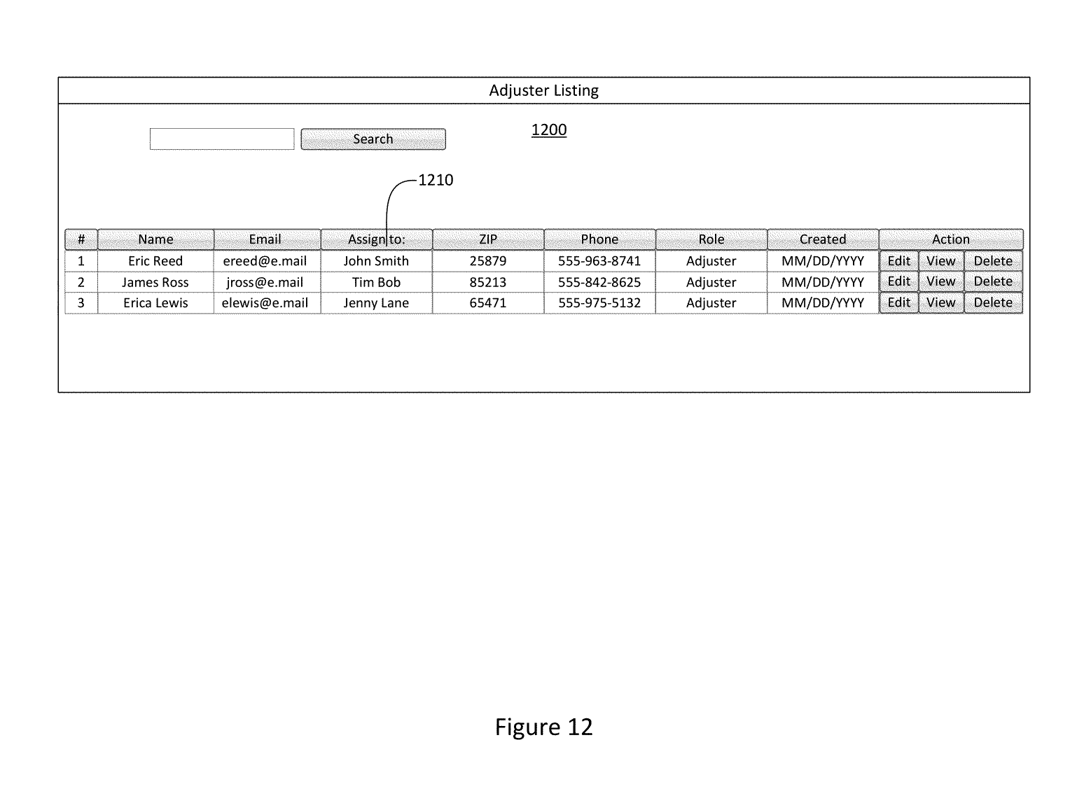

With reference now to FIGS. 11 and 12, screenshots of embodiments of scheduler listing interface 1100 and adjuster listing interface 1200 according to the present invention are provided. The scheduler listing interface 1100 lists each of the schedulers currently in the system. The number field 1110 provides a unique serial number for each scheduler that may also provide additional information about the scheduler. The name field 1120 displays the name of each scheduler, the email field 1130 displays the email address, the city field 1140 shows the scheduler's home city, the zip field 1150 displays the scheduler's zip code, the phone field 1160 displays the scheduler's phone number, the role field 1170 displays the role for each person displayed, and the created field 1180 displays the date each scheduler was added to the system. Using the buttons in the action field 1190 each scheduler entry may be edited, viewed, or deleted. Adjusters are displayed and may be managed in a similar manner to the schedulers using the adjuster listing interface 1200. However, instead of displaying a home city, the listing 1200 displays scheduler to which the adjuster is assigned. For example, in the listing interface 1200 the adjuster “Eric Reed” is assigned to the scheduler “John Smith”. The assigned scheduler manages the schedule for the insurance adjuster assigned to him or her and is also the primary point of contact for the adjuster.

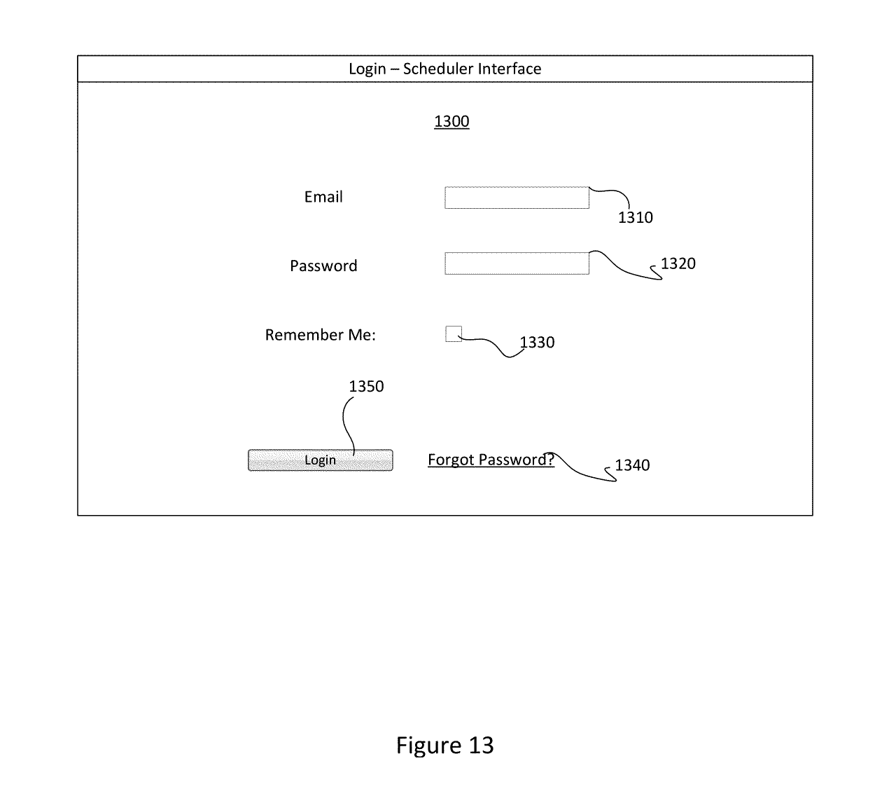

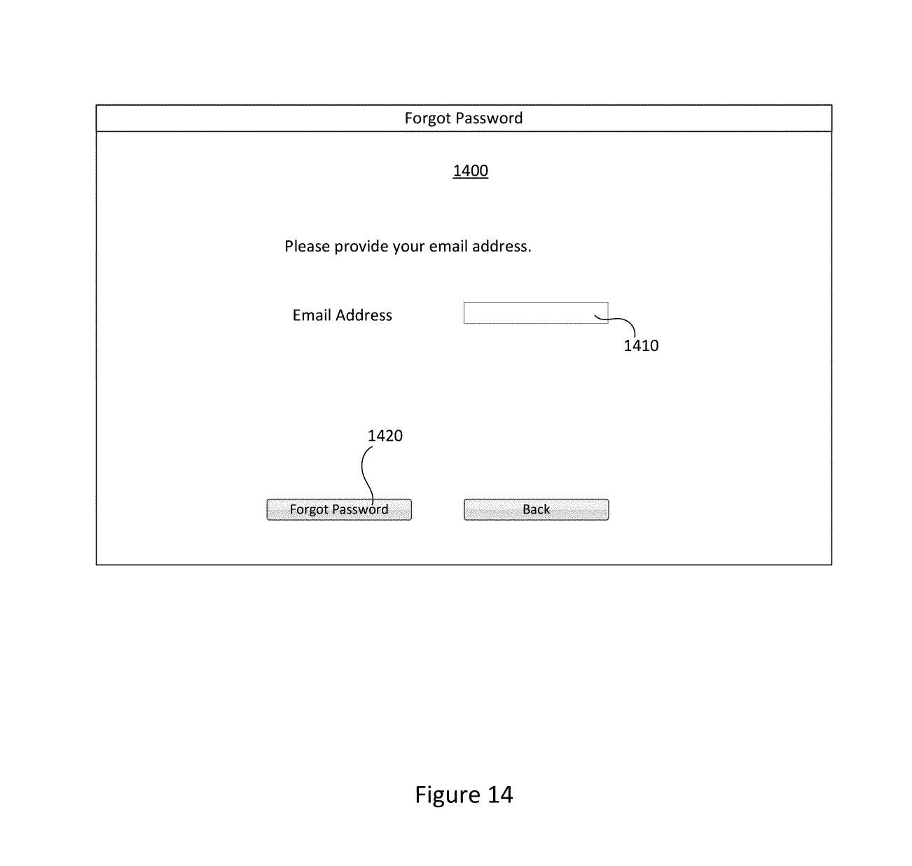

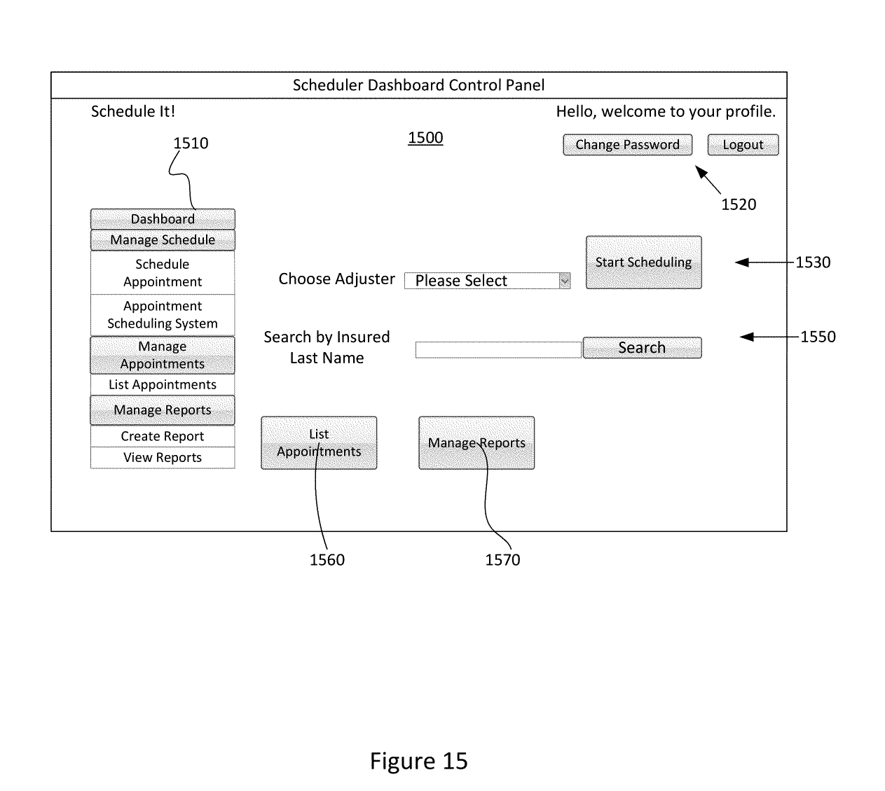

With reference now to FIG. 13, a screenshot of an embodiment of a scheduler login interface 1300 is provided. The login interface for any other user type will be similar to the scheduler login interface 1300. The scheduler login interface 1300 is used by a scheduler to log into the scheduler dashboard control panel 1500 shown in FIG. 15. To log in, a scheduler inputs the email address for their account into the field 1310, the password into field 1320, and may also opt to have the system remember their login credentials by checking the checkbox 1330. Once the login credentials have been entered, the user may log in by selecting the login button 1350. If the user cannot remember the password for the login account, the forgot password option 1340 may be selected. When selected the forgot password option takes the user to the forgot password interface 1400 shown in FIG. 14 where a user may enter the email address associated with their account in field 1410 and then submit the email address to receive a password reminder email. Other users such as administrators and adjusters may log into the system in a similar manner.

With reference now to FIG. 15, a screenshot of an embodiment of a scheduler dashboard 1500 according to the present invention is provided. The scheduler dashboard 1500 provides a scheduler with access to the scheduling functions of the system. The scheduler may select any function from the dashboard sidebar 1510 including manage schedule, manage appointments, and manage reports. Additional features are provided on the dashboard 1500 for easier access. The scheduler may use the start scheduling feature 1530 to select an adjuster to begin making an appointment. The scheduler may also search for any insureds listed in the system by last name using the insured search feature 1550. The scheduler also has access to a list of appointments using the list appointments button 1560 and report management features using the manage reports button 1570. The scheduler may use the account functions 1520 to change the password for the account or log out of the account.

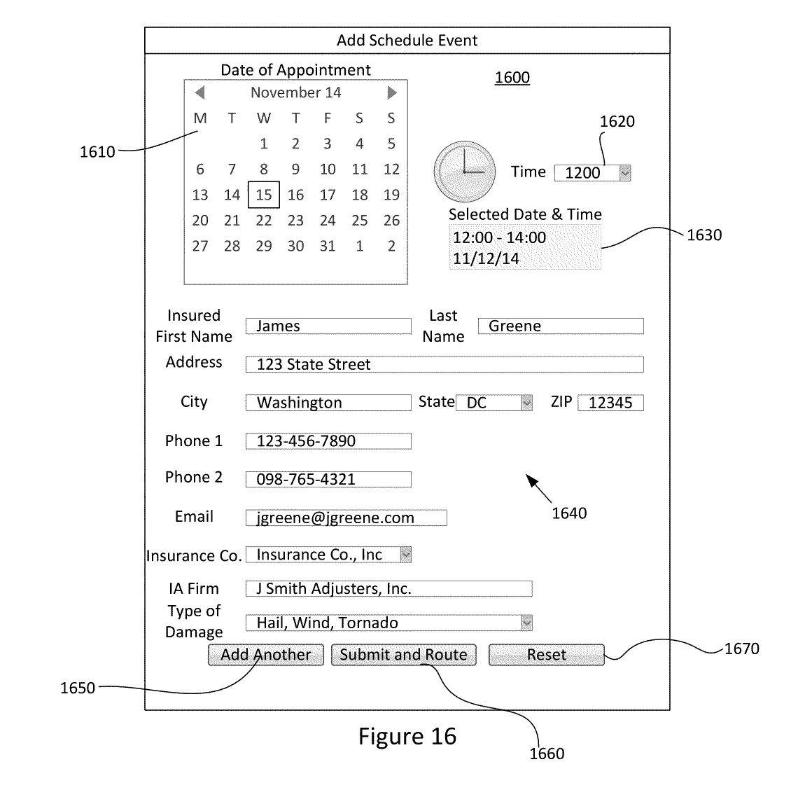

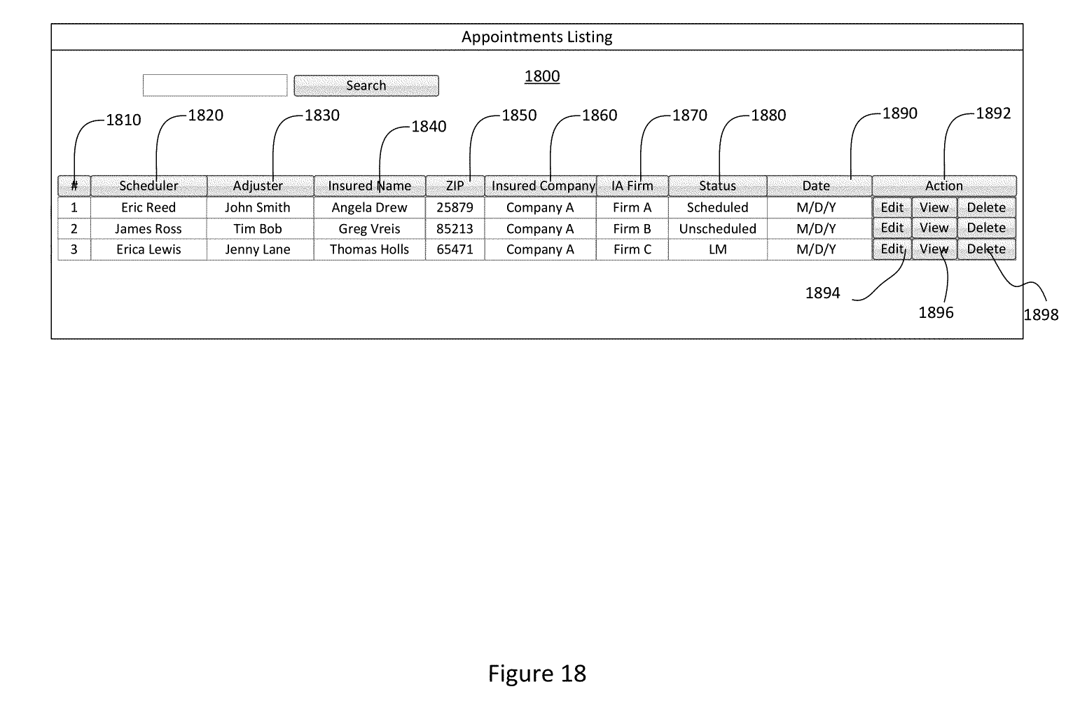

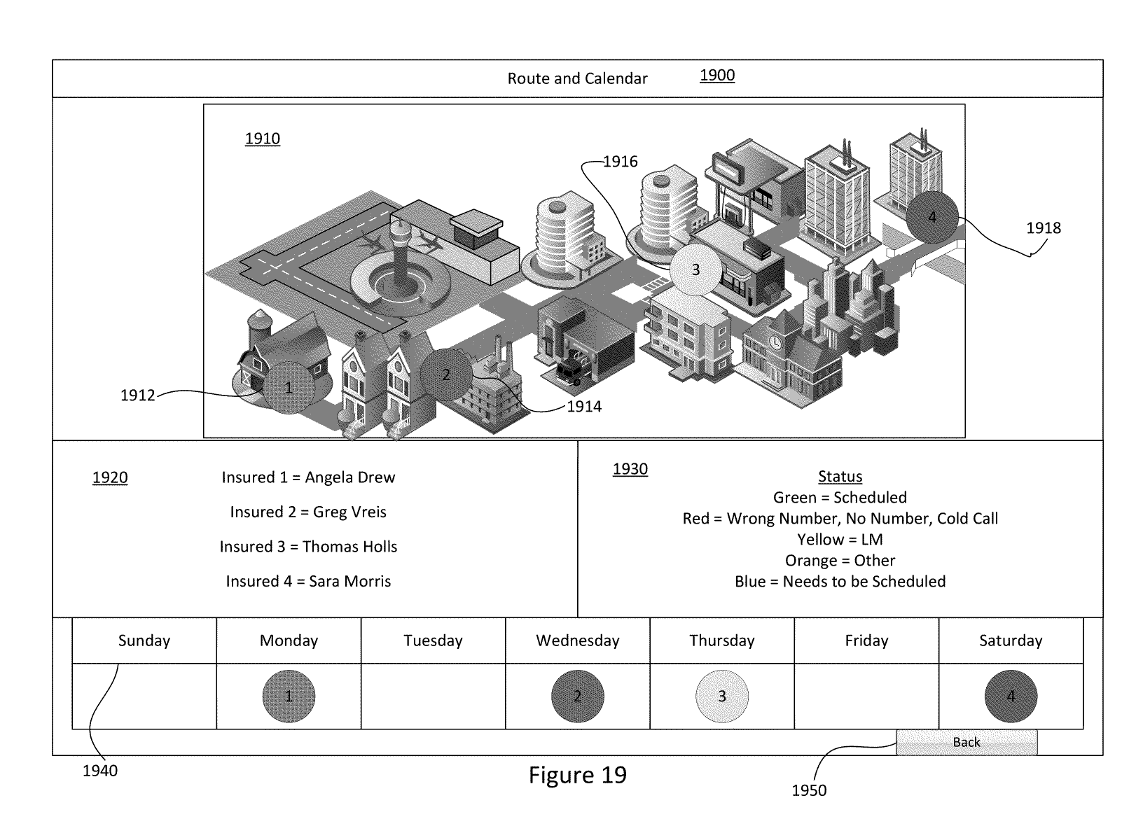

With reference now to FIG. 16, a screenshot of an embodiment of an add claim interface 1600 is provided. The add claim interface 1600 provides a scheduler with the ability to enter a new claim and may allow a scheduler to add a new claim to an adjuster's calendar. New claims and claim information may be received by email, fax, telephone and input manually or may be directly imported from software used by an IA firm. To input a new claim using the interface 1600, a scheduler may first select the date using the calendar 1610 and the time using the time field 1620. The selected date and time are shown in the appointment time field 1630. In some embodiment, the calendar 1610 and time field 1630 may be omitted. The scheduler then inputs the personal information for the insured which may include the insured's first and last name, address, phone numbers, email address, insurance policy provider, the IA firm to be used, and the type of damage. After filling out the form, the event may be submitted and routed using the submit and route button 1660. When a claim is submitted, the scheduler may be taken to the claim information interface 1700, or the additional detail may be added later using the edit button 1894 in the appointments listing interface 1800 shown in FIG. 18. If all the desired information about a schedule event has been added, the event may be routed automatically or manually using the scheduling information for an individual adjuster for display in the route and calendar interface 1900 shown in FIG. 19. Additional schedule events may be created using the add another button 1650. The add schedule event interface 1600 may be reset using the reset button 1670.

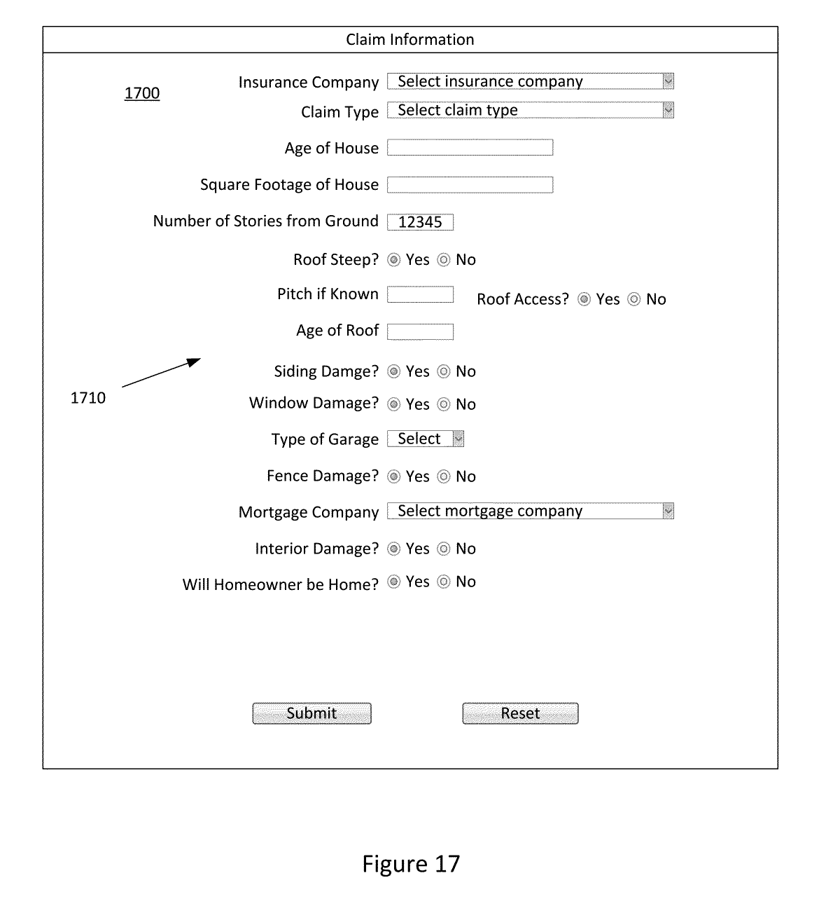

With reference now to FIG. 17, a screenshot of an embodiment of a claim details information interface 1700 according to the present invention is provided. The claim details information interface 1700 may be used by a scheduler to input additional information about a particular claim or schedule event. The claim information that may be added may include the insurance company of the insured, the claim type, the age of the insured's house, the square footage, the number of stories, whether or not the roof is steep, the pitch of the roof, whether or not there is roof access, the age of the roof, whether or not there is siding damage, whether or not there is window damage, what type of garage is present, whether or not there is fence damage, the insured's mortgage company, whether or not there is interior damage, and whether or not the homeowner will be home. The type of information that may be entered may depend on the claim type and different fields will be displayed based on the type of claim selected. For example, if flood damage is the type of claim, information relating to the nature of the flood damage, the highest water level, the rooms affected by the flood damage, etc. may be displayed in the claim information interface 1700. For other types of claims including fire or smoke, water/freeze, hurricane, and commercial claims context specific information pertaining to those claims will be displayed to the user for input.

With reference now to the FIG. 18, a screenshot of an embodiment of an appointments listing interface 1800 is provided. The appointments listing interface 1800 displays all presently entered appointments and the details and status for each appointment. Each appointment is assigned a number shown in the appointment number field 1810. Additional information is shown in the other fields including the scheduler name in the scheduler field 1820, adjuster name in the adjuster field 1830, insured name in the insured field 1840, insured's zip code in the zip field 1850, insured's insurance company in the insurance company field 1860, the IA firm for the appointment in the IA firm field 1870, the status of the appointment (e.g. scheduled, unscheduled) in the status field 1880, and the date of the appointment in the date field 1890. The action field 1892 may include one or more function buttons including an edit button 1894 that provides for the editing of the details of any appointment, a view button 1896 that displays a read only interface comprising the details for a selected appointment, and a delete button 1898 for deleting an appointment from the system.

With reference now to FIG. 19, a screenshot of an embodiment of a routing and calendar interface 1900 is provided. The routing and calendar interface 1900 displays the routing information and daily, weekly, or monthly calendar for an individual claims adjuster. The routing information is shown in the map 1910 and the calendar 1940 is shown at the bottom of the interface 1900. The map 1910 may be provided by any mapping program including Google Maps, Bing! Maps, MapQuest, Apple Maps, etc. and will include the location and status of each appointment for the adjuster for the time period shown in the calendar 1940. In the map 1910 a series of appointments are shown. The detail for each appointment is indicated by the status color which may be referenced in the status legend 1930, and the appointment detail field 1920. The appointment 1912 for the first insured is shown as a green circle with a one in the circle. The shape and color of the appointment marker as well as the markers' contents may vary. The routing and scheduling interface 1900 shows that this appointment 1912 is for Angela Drew and that the appointment is scheduled for Monday. The appointment 1914 is for Greg Vries and is scheduled for Wednesday, but the color of the marker indicates that the appointment information contains a wrong phone number. The appointment 1916 is for Thomas Holls and is scheduled for Thursday and the color of the marker for the appointment 1916 indicates that a message was left but not returned. The final appointment 1918 is for Sara Morris and is scheduled for Saturday, but this is merely a placeholder at the end of the week as the actual time and date have not been scheduled as indicated by the color of the appointment 1918 marker. The map 1910 also displays the geographic location of each of the appointments. If multiple appointments are scheduled in a single day, the optimal routing to each appointment will be shown. If appointments are scheduled for different days of the week and are in different cities or counties, the optimal routing for these appointments will be calculated and shown. The schedule for each adjuster will be planned either automatically or by a scheduler to accommodate the best possible routing between appointments.

The scheduling and management system 100 links insurance claims entered in the system and scheduled by a scheduler to the routing and scheduling interface 1900. The system 100 may estimate mileage between two coordinates or appointments which may be an adjuster's deployed address and an appointment or between two loss locations. The routing may also take into consideration the scheduling rules saved for any individual adjuster including number of appointments per day, appointment duration, start time, and start date. An adjuster may view their calendar 1940 in increments of day, week, or month, and the information shown in the map 1910 and detail field 1920 will automatically display the appointment information for the time range specified in the calendar. In one embodiment, a personal scheduler is not used for an adjuster and the adjuster has access to a scheduler type dashboard for scheduling their own appointments.

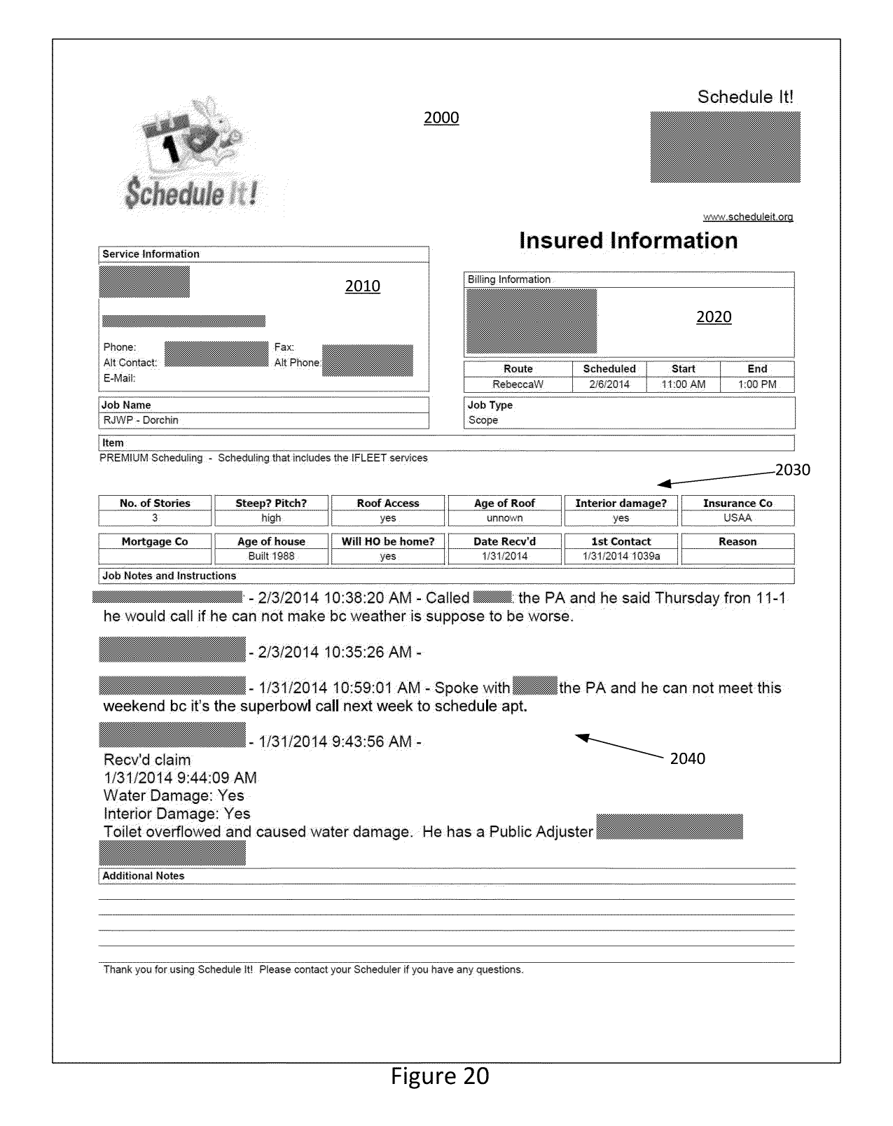

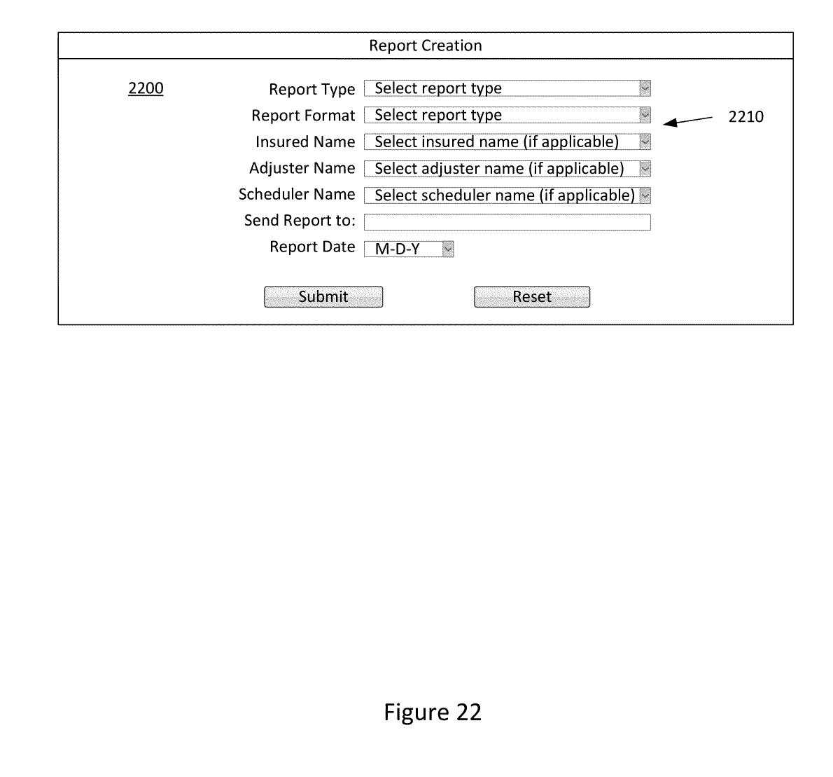

With reference now to FIGS. 20, 21, and 22, an embodiment of a claim received report 2000, a report listing interface 2100, and a report creation interface 2200 according to the present invention is provided. The report 2000 may be created by the report creation interface 2200. Details relating to the report may be entered using the report details fields 2210 and may include report type, report format, insured name, adjuster name, scheduler name, report recipients, and report date range. Additional fields may be included in the report details fields 2210 for adding report details, schedule contact events, etc. Contact events and other details may also be added in a details field in the claim information interface 1700 shown in FIG. 17. The report 2000 may comprise information selected using the report creation interface 2200 or may comprise information automatically included in a particular report. The information included in the report may include service information 2010, billing information 2020, claim information 2030, and contact/event log 2040. Additional notes may be added directly to the report 2000 and saved to the report. The format of and information included in the report 2000 will be context based and will depend on the report type and options selected in the report creation interface 2200.

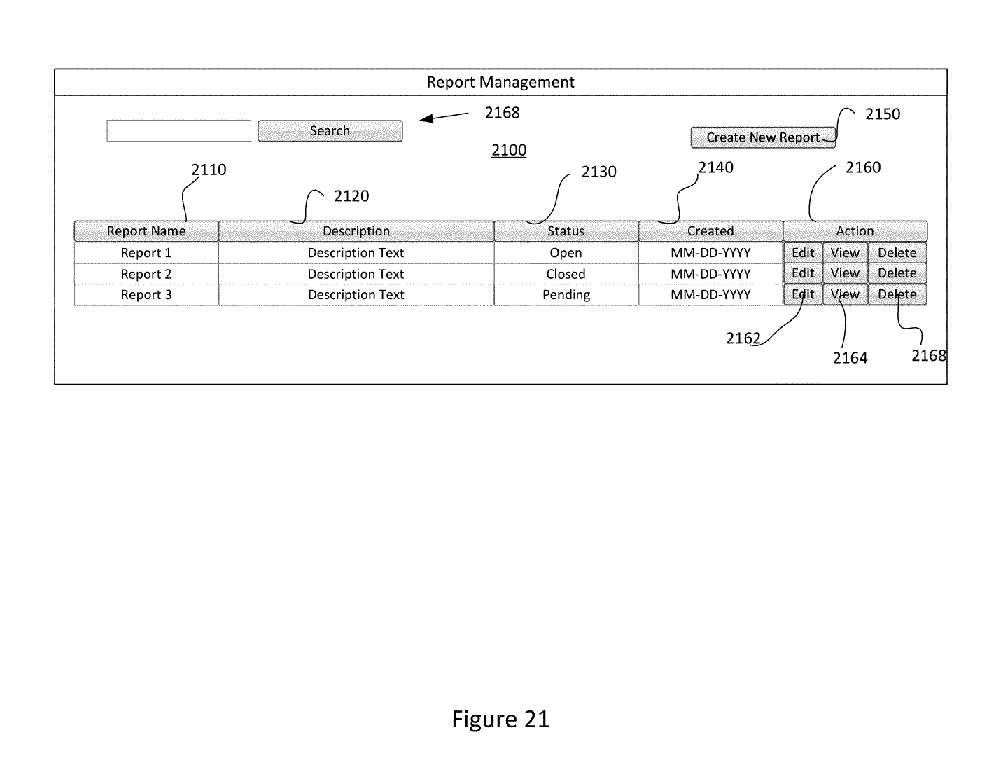

Reports currently in the system may be viewed using the report management interface 2100 shown in FIG. 21. The report management interface 2100 may comprise a report name filed 2110 for displaying the report name, a description field 2120 for displaying a brief description of the report, a report status field 2130 for displaying a report's status, and a created field 2140 for displaying the date of a report's creation. A new report may be created using the create new report button 2150 and existing reports may be edited using the edit button 2162 in the action field 2160. Reports may also be viewed using the view button 2164 or deleted using the delete button 2166. A user may search for an existing report using the search field 2168.

In one embodiment of the invention, an adjuster is assigned to a scheduler by a system administrator and the scheduler is assigned the responsibility of scheduling all appointments or meetings for loss events for the adjuster assigned to that scheduler. For a new meeting, claim/loss event, or appointment, the scheduler may select an insured already in the system, a previous claim, or may enter new information to schedule an appointment. After the appointment is scheduled and all claim information is added, the appointment will be routed and displayed as shown in the routing and calendar interface 1900 shown in FIG. 19. After route information has been calculated and a schedule has been generated, the scheduler may update or add details about the insured, the claim, or the appointment using either the add schedule event interface 1600 or claim information interface 1700. A scheduler may enter the claim, insured, and appointment information when an appointment is initially created or may add the information at a later time after the appointment has been scheduled and routed. After an appointment has been scheduled and routed, either the scheduler or adjuster may use the system 100 to add additional information or edit existing information about the insured, claim, or appointment. After an appointment has concluded, billing information may be processed by the system 100 or sent to an external billing system such as QuickBooks.

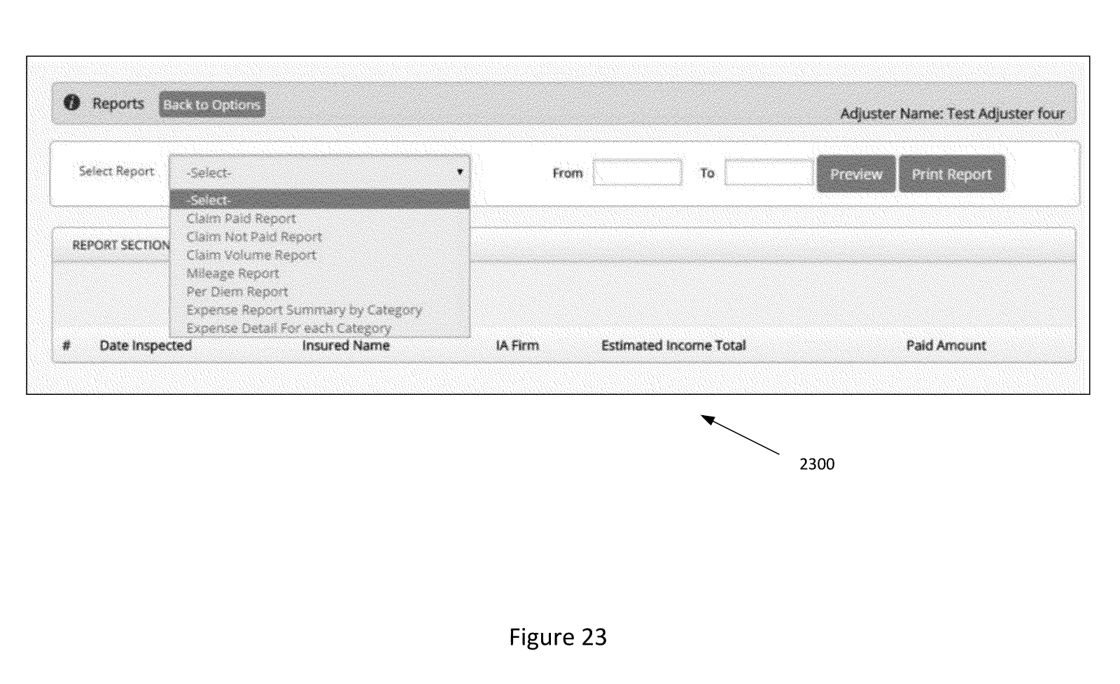

With reference now to FIG. 23, a screenshot of an embodiment of a report creation interface 2300 is provided. The report creation interface may be used to select a report type desired by the user. The report may be, but is not limited to, a claim paid report, a claim not paid report, a claim volume report, a mileage report, a per diem report, an expense report summary by category, and an expense detail report for each category. The user may also view a daily claims received report, or an insured information report.

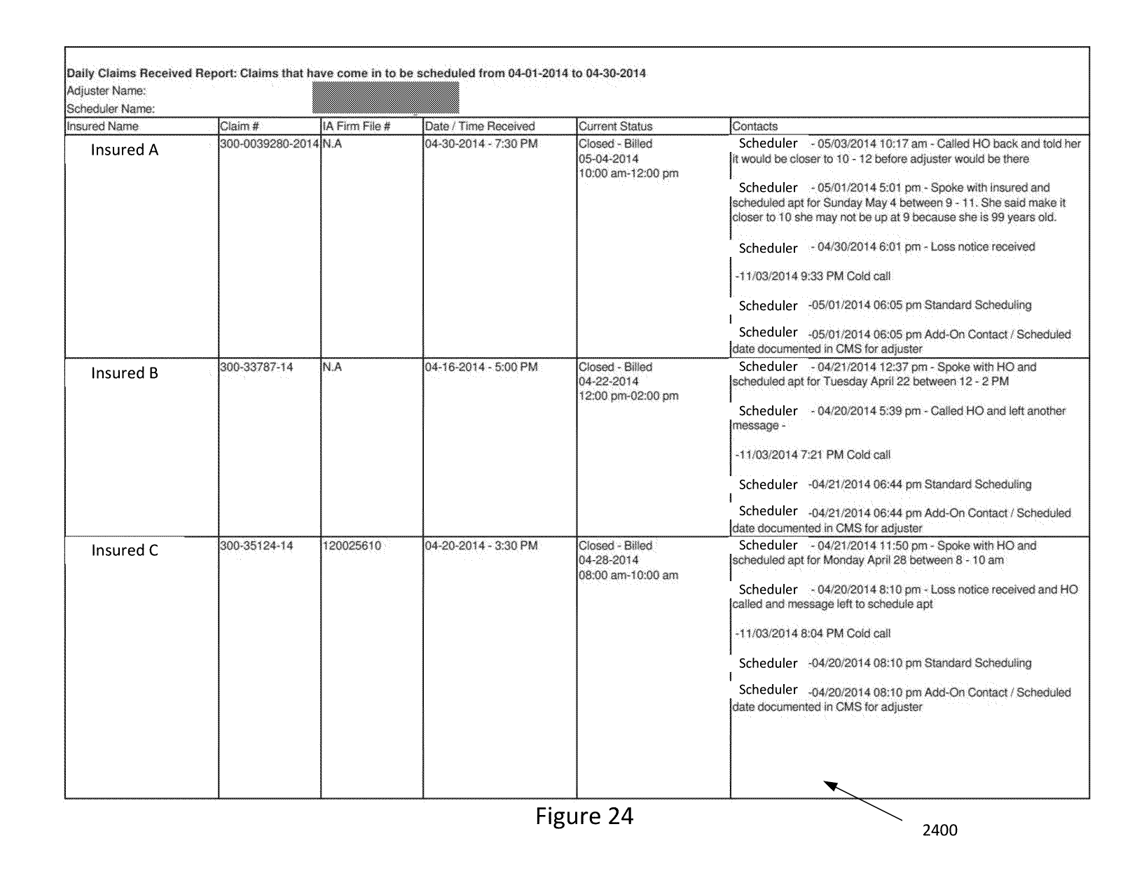

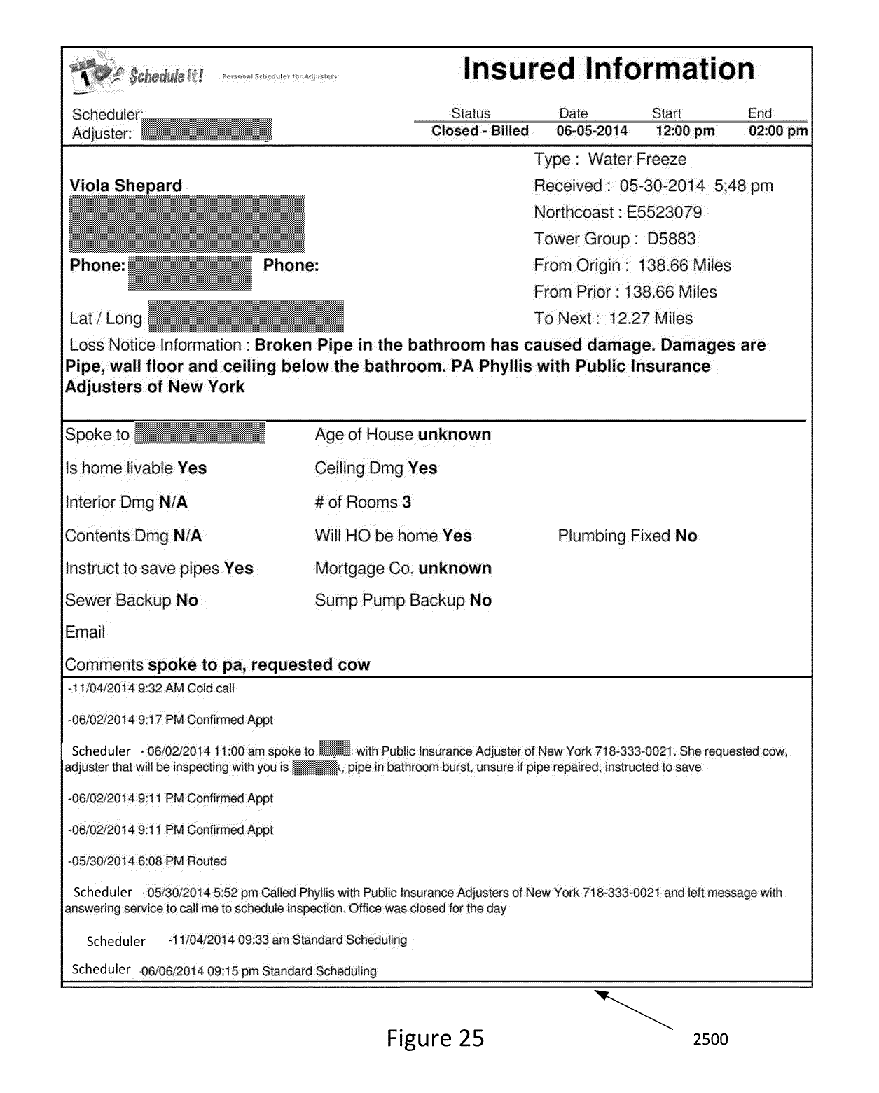

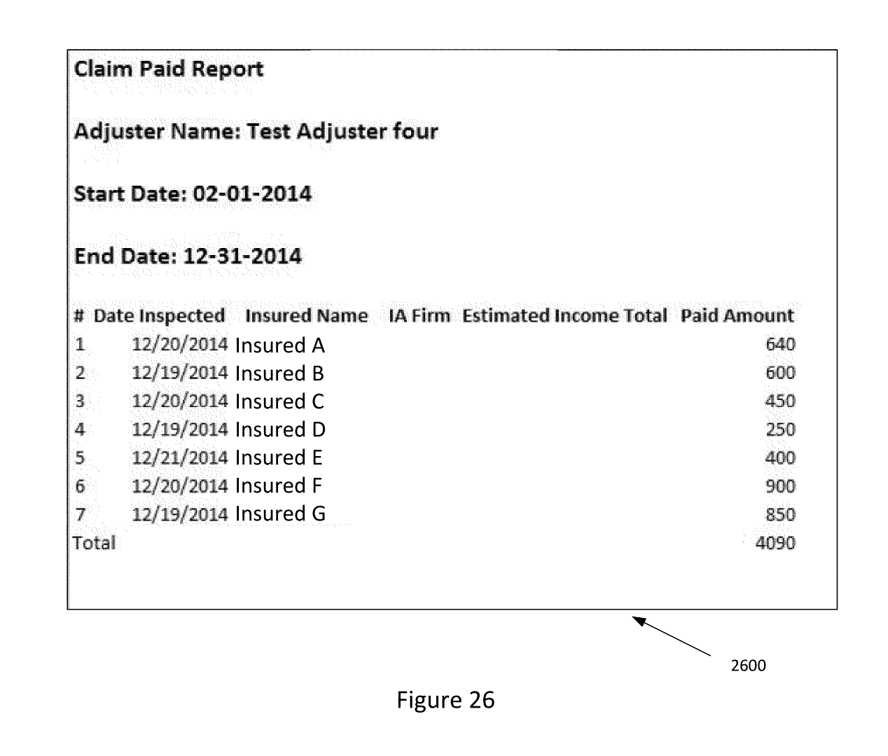

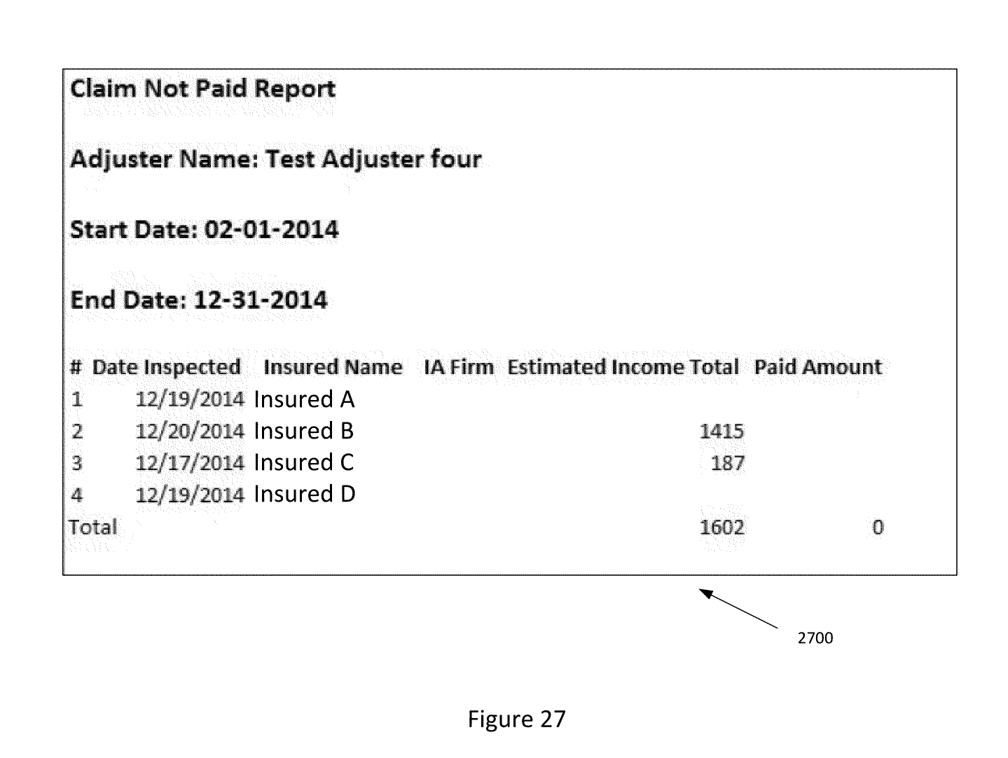

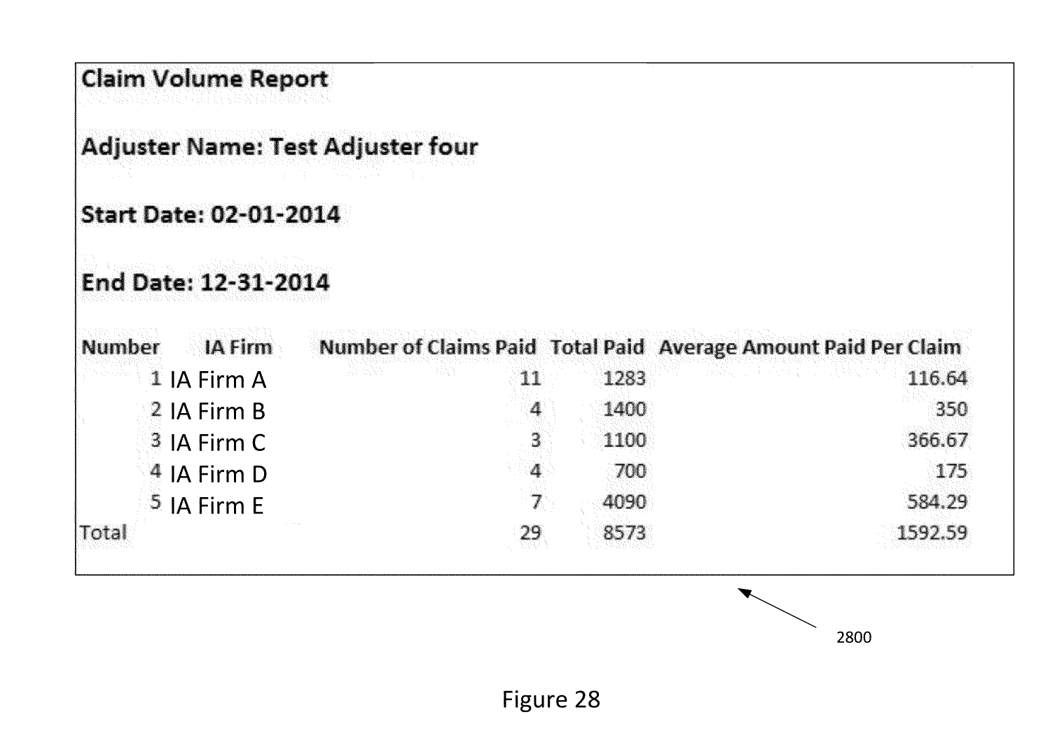

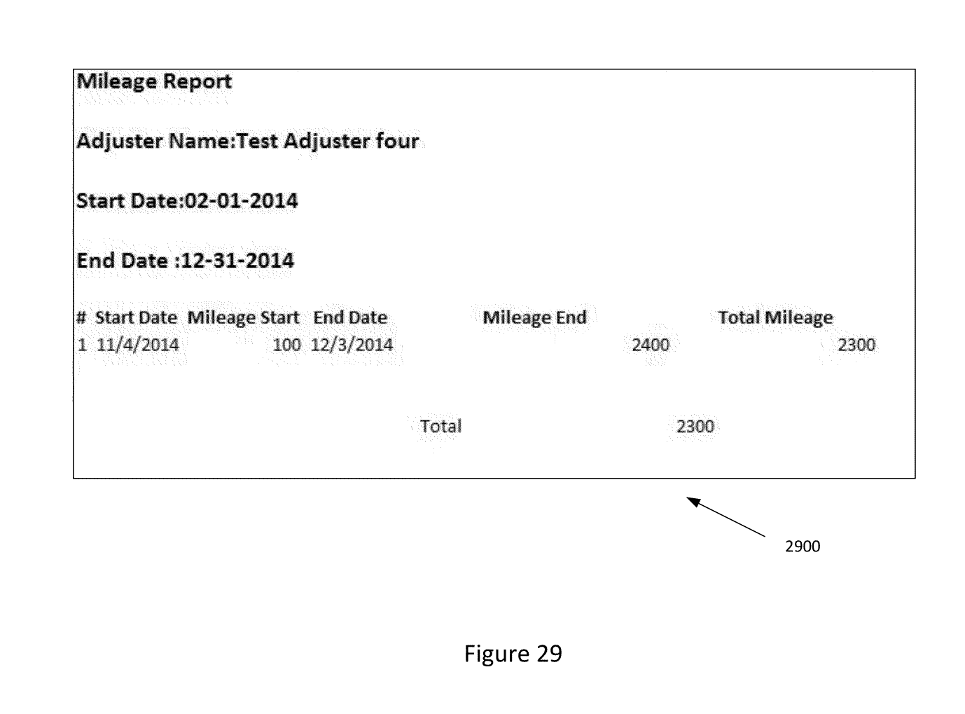

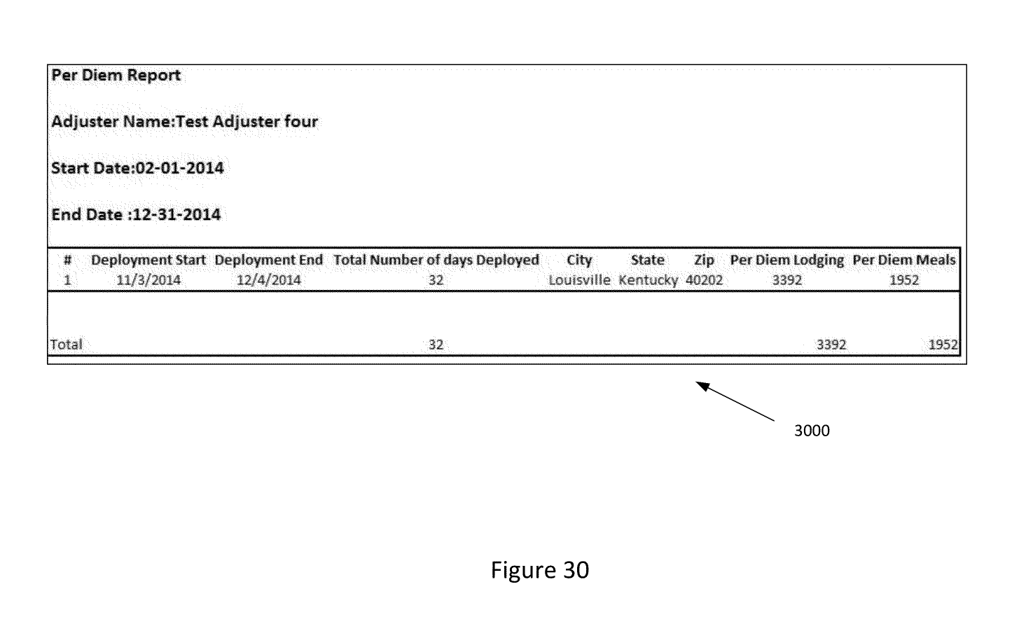

With reference now to FIGS. 24-32, several embodiments of reports according to the present invention are provided. The daily claims received report 2400 shown in FIG. 24 provides a list of the claims received over a particular time period. The daily claims received report may comprise the insured name, the claim number, the IA firm file number, the date and time the claim was received, the current status of the claim, and the contact log for the claim. The insured information report 2500 in FIG. 25 provides an overview of the information about the insured, the insured's claim, and any contacts with the insured. The information in the insured information report 2500 provides a view of information such as instructions regarding the claim, the claim's status, and what communications have been made with the insured. The claim paid report 2600 in FIG. 26 provides information on how much has been paid for each claim assigned to a particular adjuster. The claim not paid report 2700 shown in FIG. 27 provides information related to claims that have not yet been paid for a particular adjuster. The claim not paid report may also show the estimated income for each claim not paid. The claim volume report 2800 shown in FIG. 28 provides a summary of the number of claims paid by all IA firms that an adjuster has worked for. The claim volume report 2800 provides the total amount paid by for each IA firm, the number of claims paid, and the average amount paid per claim. The mileage report 2900 shown in FIG. 29 provides the total mileage traveled by an adjuster over a particular time period based on the beginning and ending mileage amounts entered by the claims adjuster for a specific time period. The per diem report 3000 shown in FIG. 30 provides a summary of the per diem earned by an adjuster over a particular time period or for a particular deployment period.

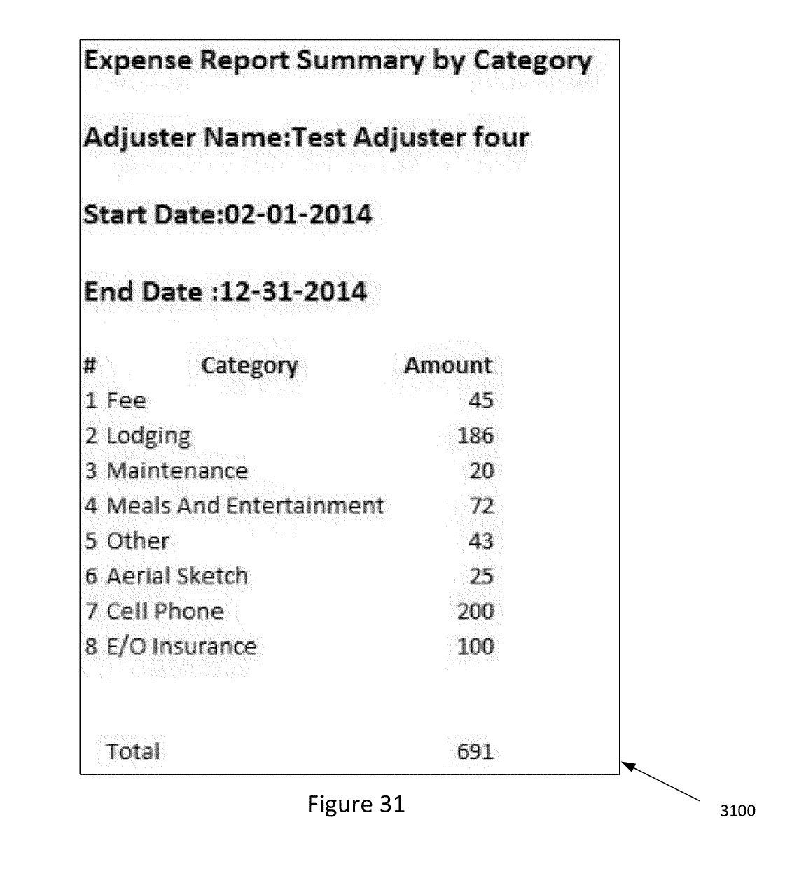

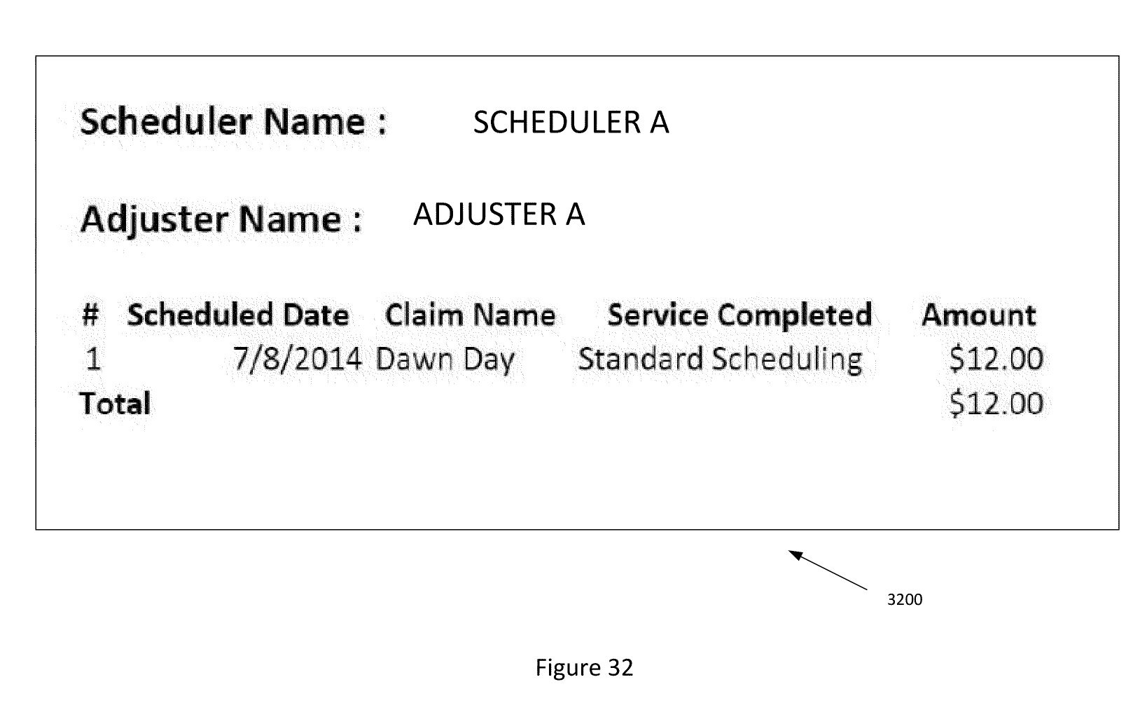

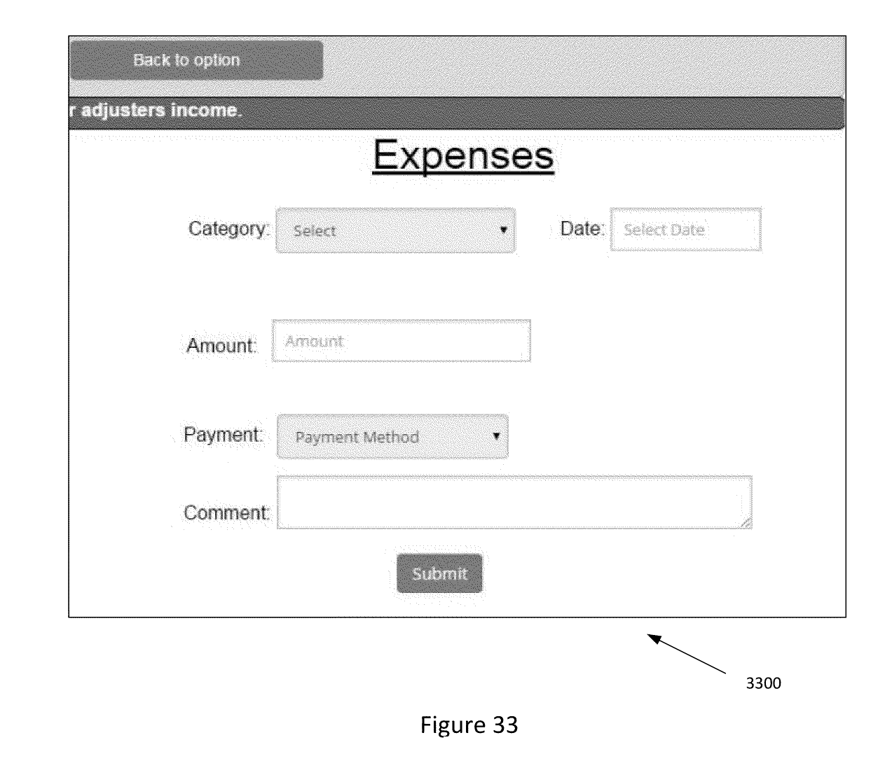

The expense report 3100 shown in FIG. 31 provides a breakdown of the expenses incurred by an adjuster for a any category with expenses entered by the insurance adjuster for a specific time period. The expense report 3100 is particularly useful for the adjuster for tax purposes. A user may input expenses using the expenses interface 3300 shown in FIG. 33. The expenses interface 3300 allows a user to select at type of expense and then prompts the user to input additional information related to the expense type selected. The expense report 3100 is generated based on the expenses entered by the user in the expenses interface 3300. Invoices, such as invoice 3200 shown in FIG. 32, may also be generated by the system. The invoice 3200 is for scheduling services for an adjuster, but other invoice types for other users and other services may also be generated by the present invention.

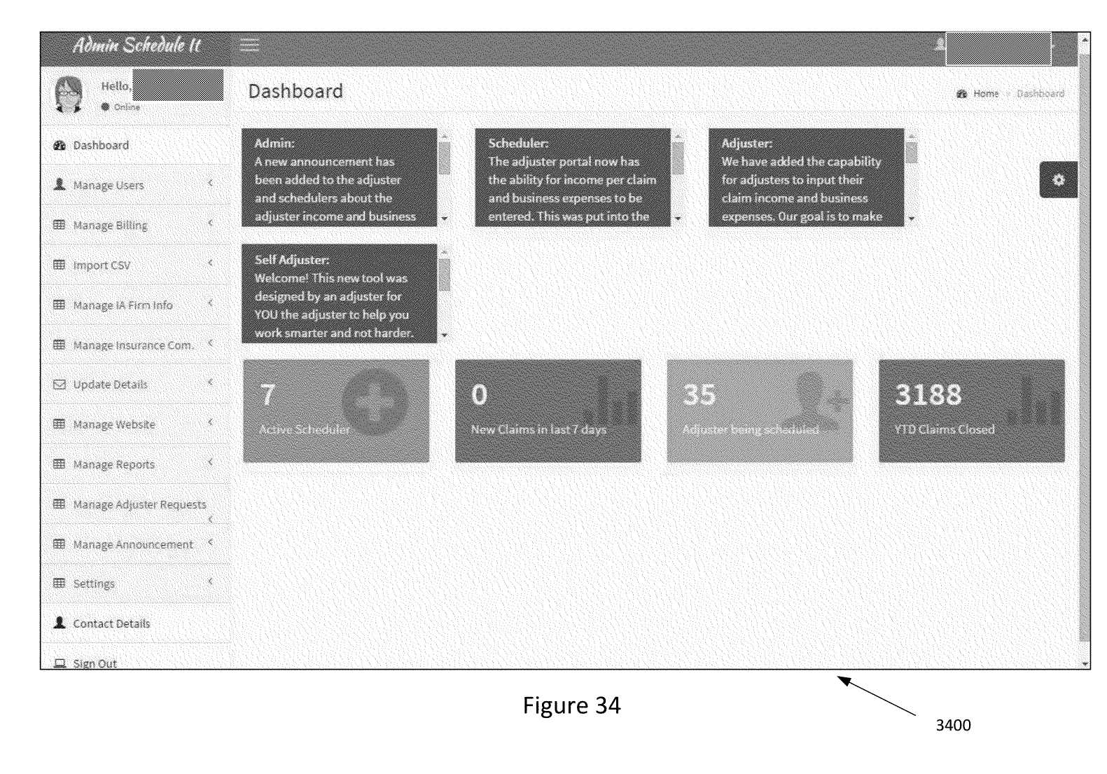

With reference now to FIGS. 34-42, screenshots of embodiments of aspects of an administrator interface are provided. The administrator dashboard 3400 shown in FIG. 34 may immediately provide an administrator with useful information relating to new claims, claims closed, active schedulers, and adjusters being scheduled. The dashboard 3400 also provides an administrator with access to a set of tools that provide the administrator with the ability to manage users, manage billing, import comma separated value (“CSV”) files, manage IA firm information, manage insurance companies, update details, manage website, manage reports, manage adjuster requests, manage announcement, contact details, and change system settings. The administrator can immediately access all necessary tools directly from the dashboard 3400.

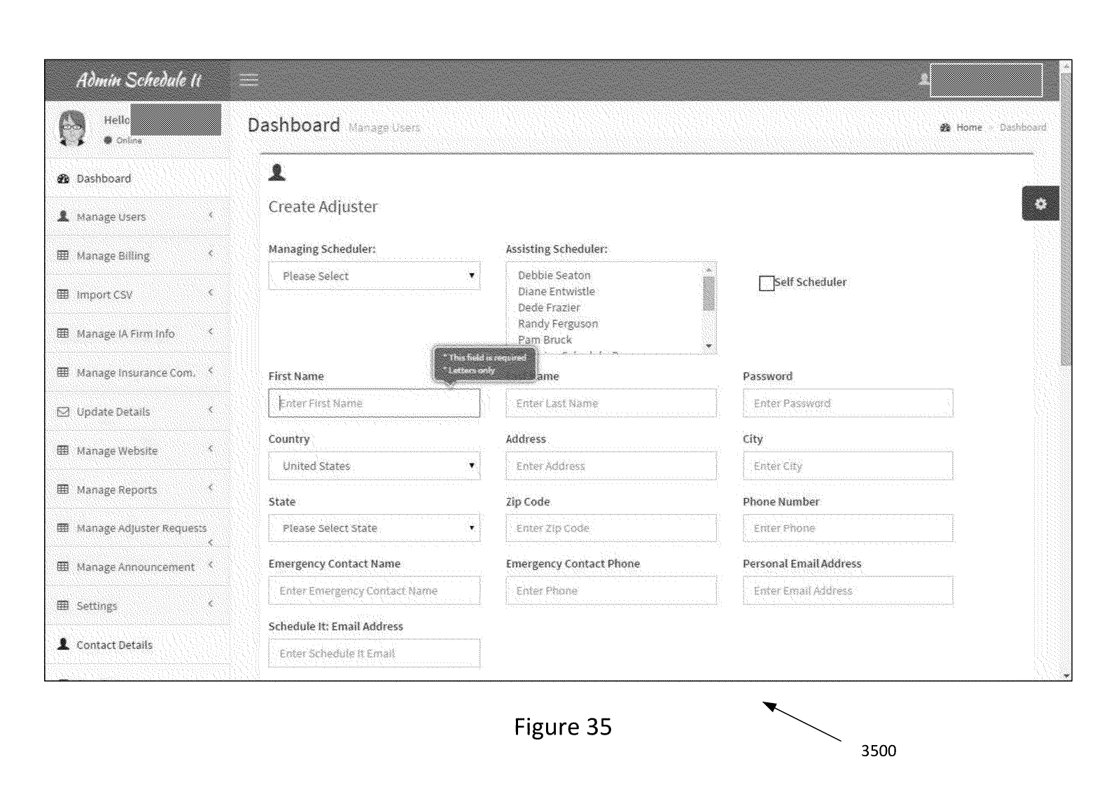

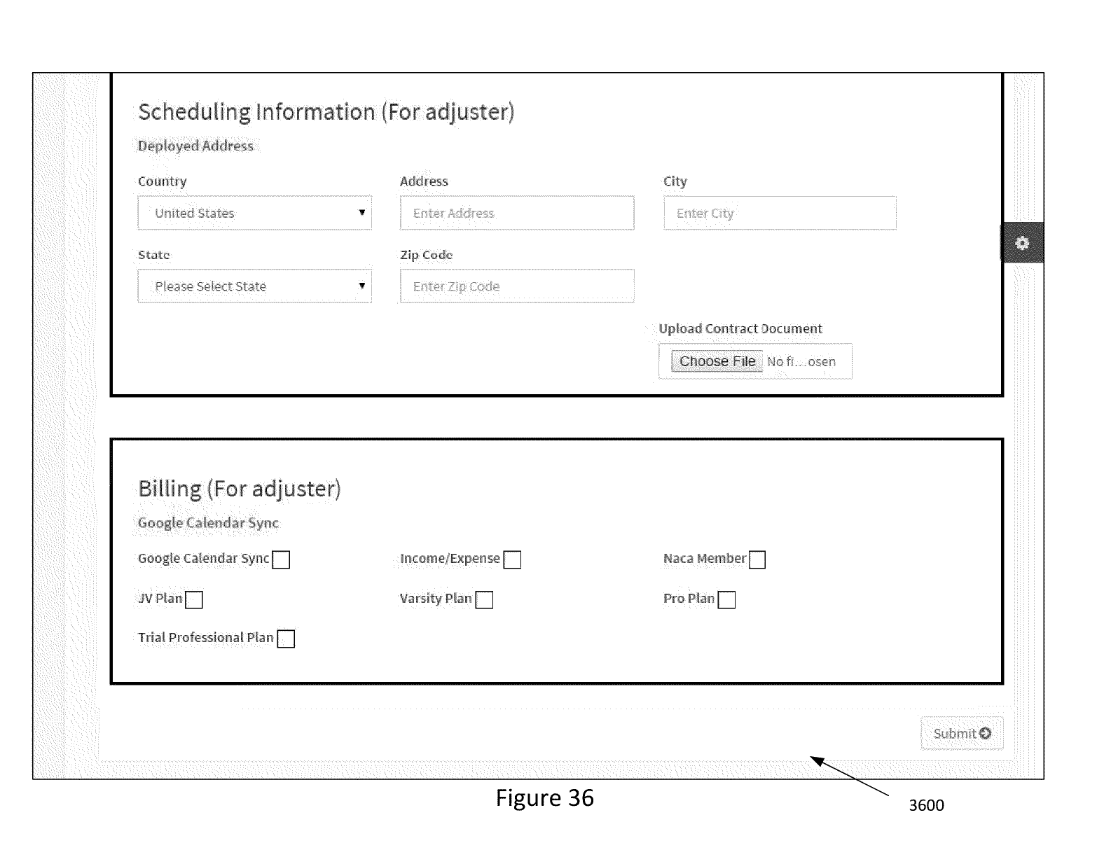

The create adjuster interface 3500 shown in FIG. 35 provides an administrator with the ability to add an adjuster to the system. The administrator may input details about the adjuster and assign a scheduler to the adjuster. FIG. 36 provides a view of additional information 3600 that may be added for a new adjuster. The additional information may comprise scheduling information and billing information. The scheduling information determines the deployment address for the adjuster which is used for scheduling and routing appointments. The billing information determines how an adjuster will handle billing information.

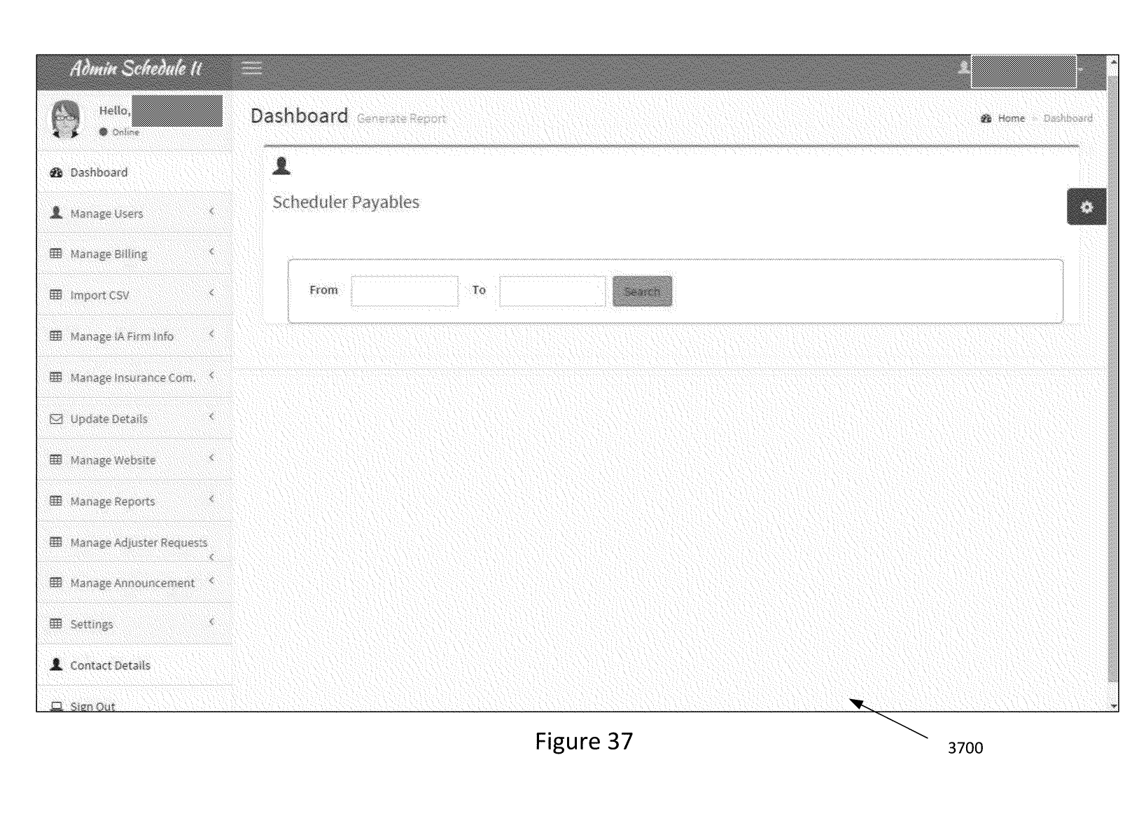

The scheduler payables interface 3700 shown in FIG. 37 provides an administrator with the ability to see all payables for all schedulers for a desired time period. The information generated by the scheduler payables interface 3700 may also be used to generate a report.

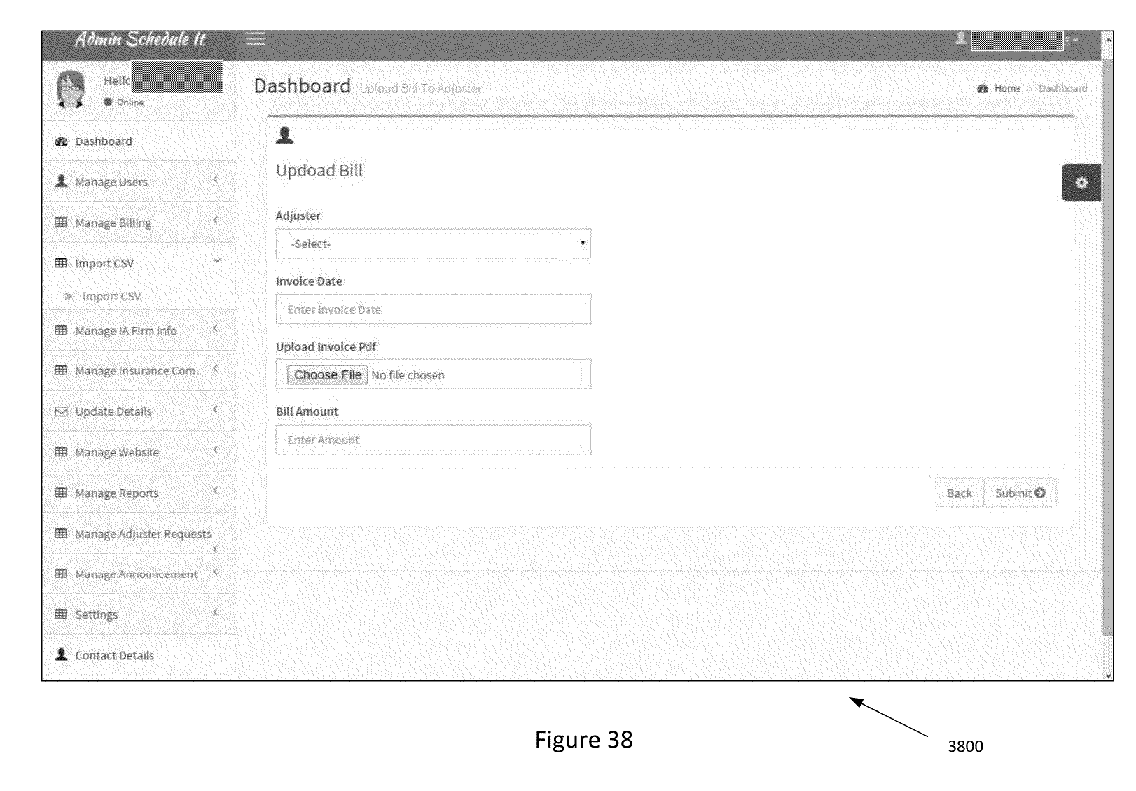

The upload bill interface 3800 shown in FIG. 38 provides an administrator with the ability to upload a bill into the system. The bill may be in PDF or other document formats and the administrator may also use the interface to specify the adjuster associated with the bill, the date of the invoice, and the amount of the bill.

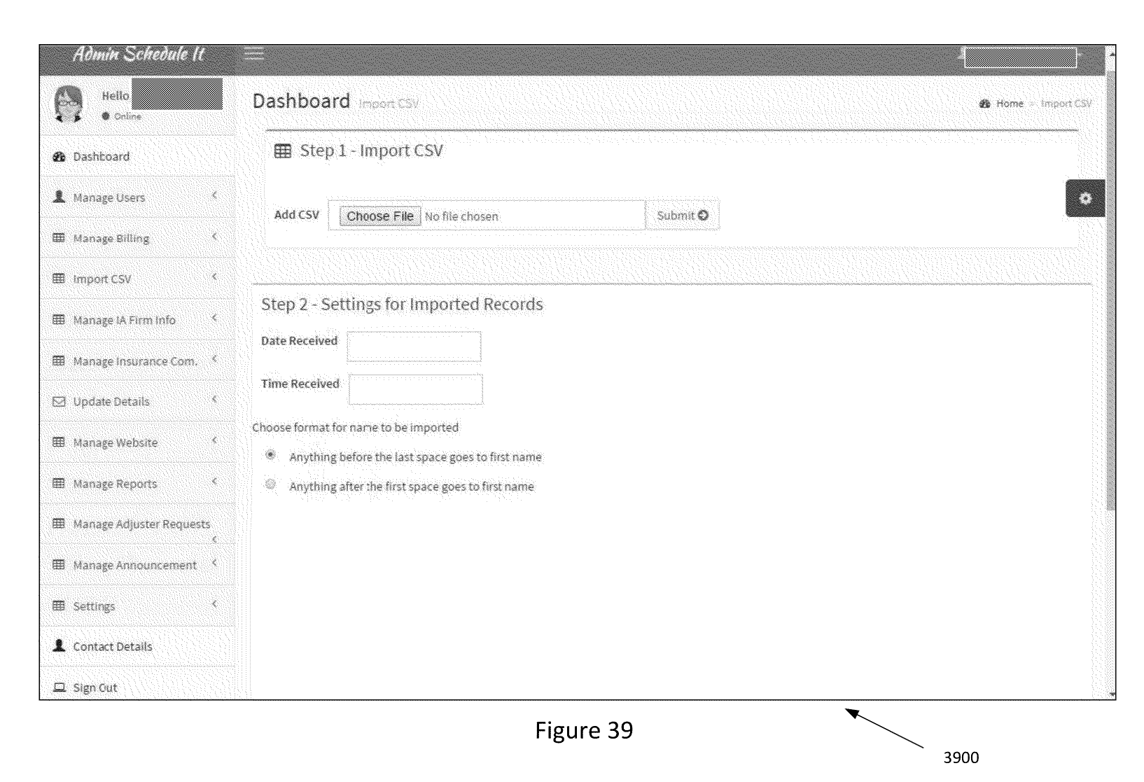

With the import CSV interface 3900 shown in FIG. 39, an administrator or scheduler may import a CSV file into the system. The imported CSV file may comprise information for a set of claim appointments for one or more insured, adjusters, or claims. After a CSV file is imported, any headers in the CSV file must be matched to data field types already in the system. For example, if a CSV file has a header with the name “Work” with data types that appear to be phone numbers, the user of the system would need to assign that header the “Phone 1” or “Phone 2” header in the CSV interface 3900 after the CSV file is imported. Additionally, other data types may be imported by CSV file.

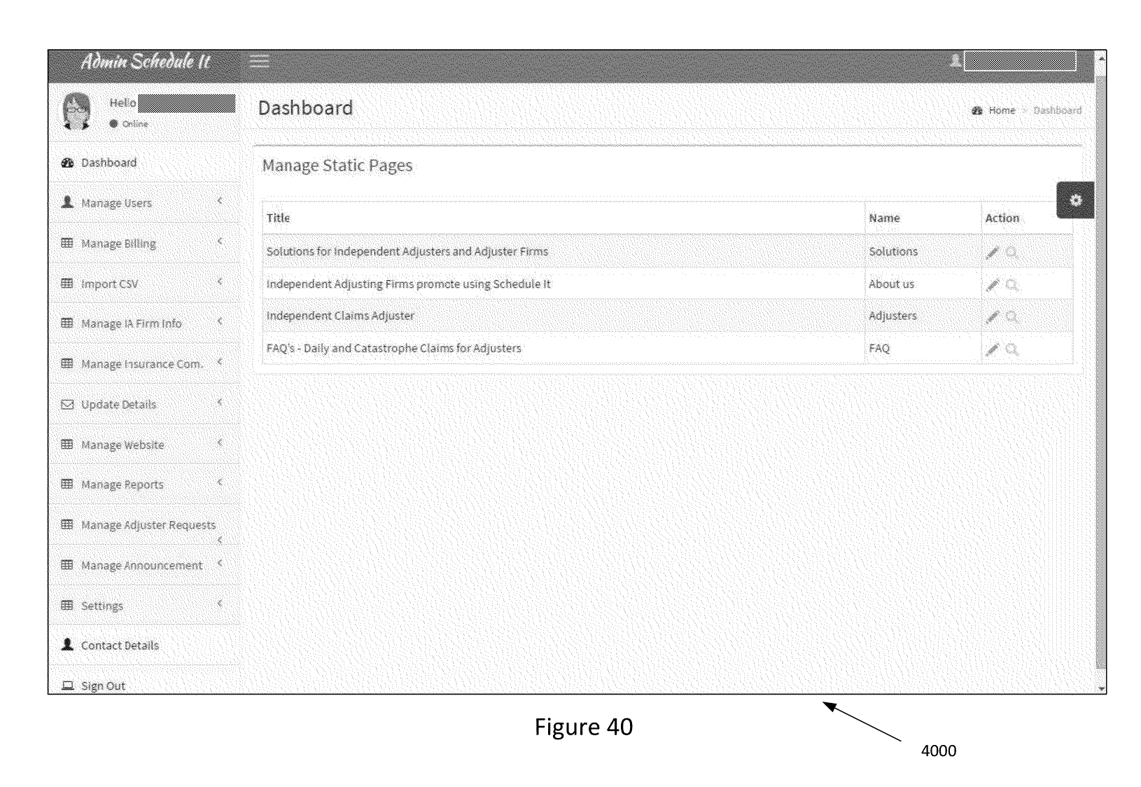

The manage static pages interface 4000 shown in FIG. 40 provides a user with the ability to create, view, and edit static pages that may be viewed by other users. These static pages may contain useful information, tips, updates, news, or any other information that need to easily viewable by users of the system.

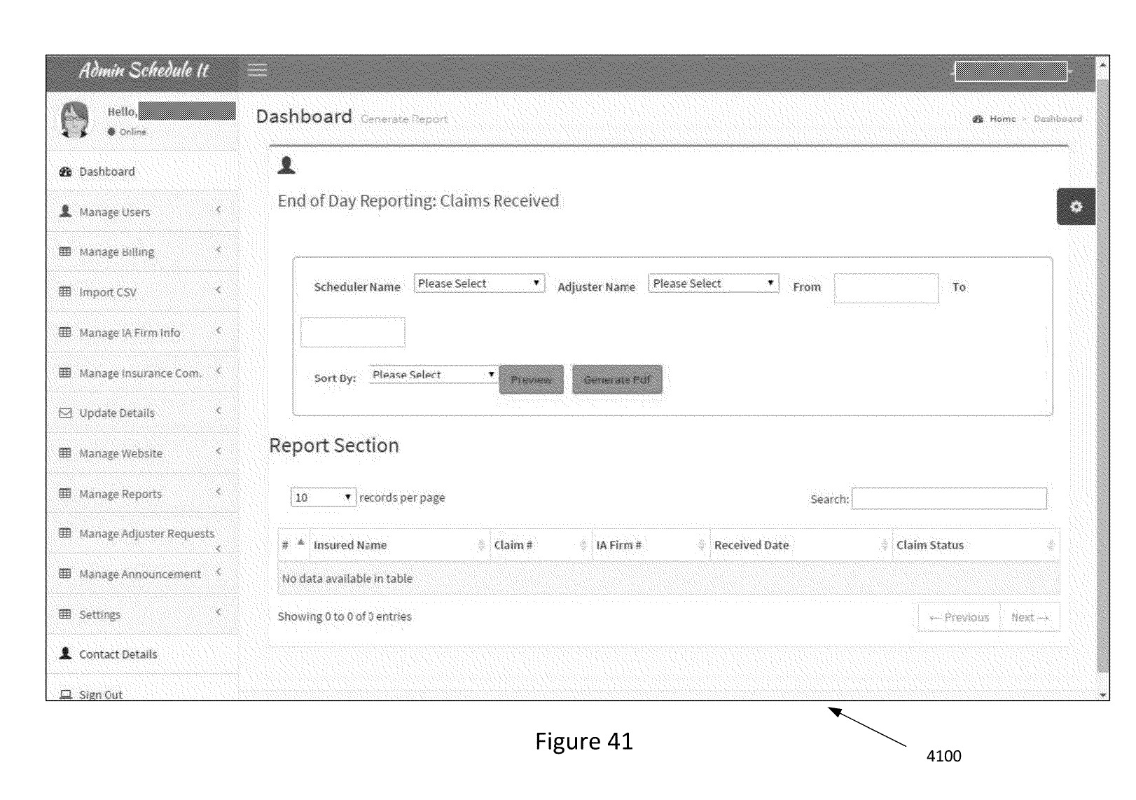

A user may also view certain end of the day reports using the end of day reporting interface 4100 shown in FIG. 41. The parameters for the report may be input by the user and then the report will be displayed in the end of day reporting interface 4100.

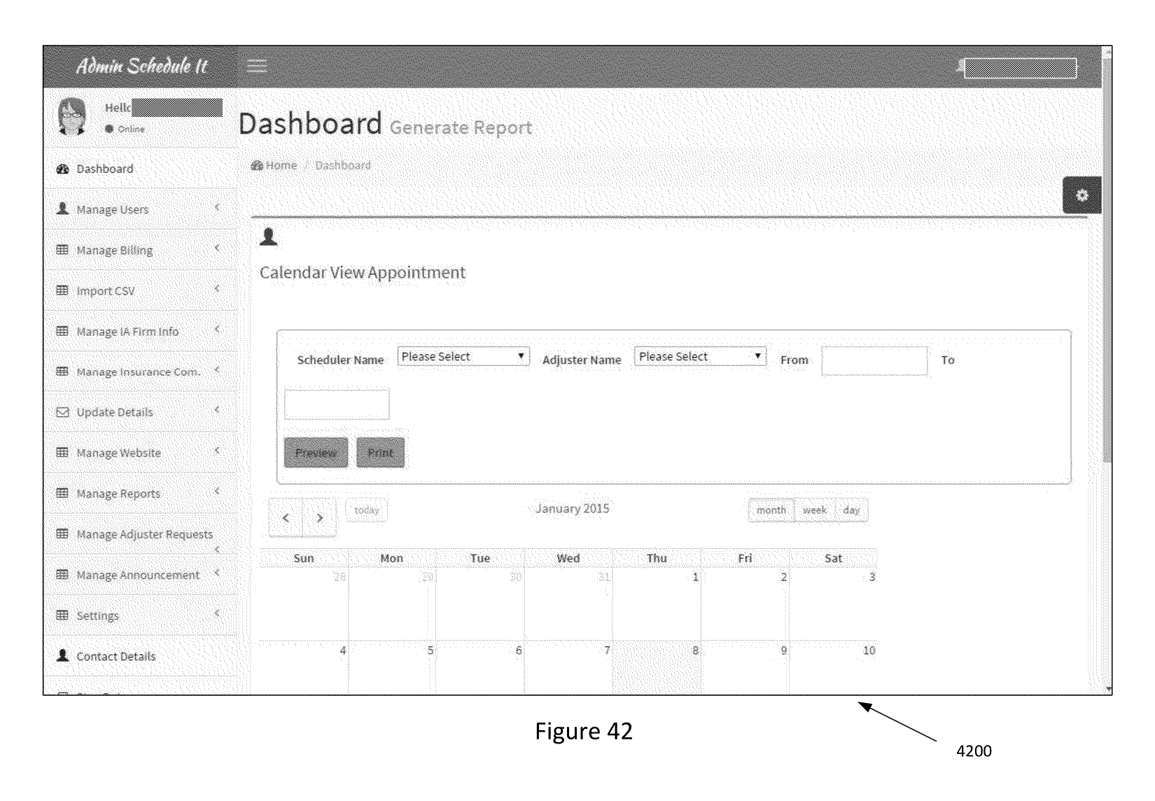

The calendar view appointment interface 4200 shown in FIG. 42 provides a user with access to a calendar that displays all appointments scheduled for a desired time period. An administrator may use the interface 4200 to view the calendars for any particular scheduler and/or adjuster while adjusters and schedulers may only see calendars associated with their user accounts. For example, a scheduler may be able to see the schedules for each adjuster associated with the scheduler while an adjuster may only be able to see their own schedule.

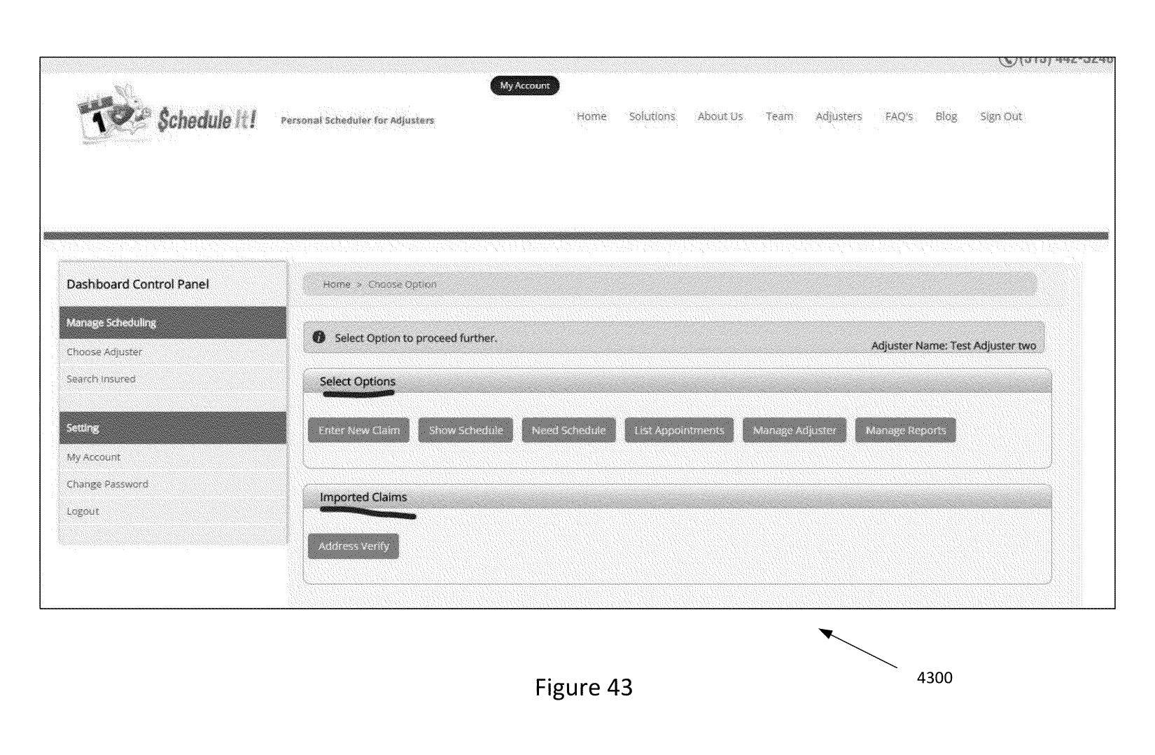

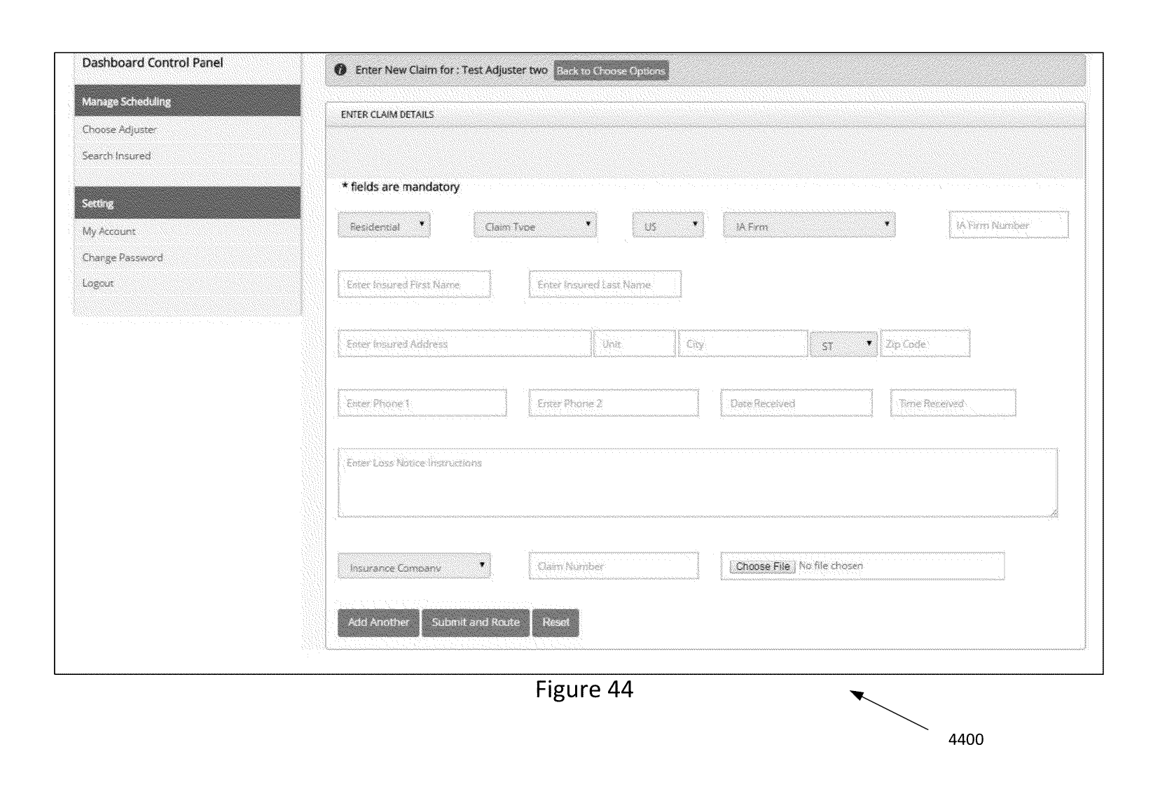

With reference now to FIGS. 43-46, screenshots of embodiments of a scheduler or self-scheduling adjuster interface are provided. From the management interface 4300 shown in FIG. 43, a user may enter a new claim, view a schedule, see what appointments are not scheduled, view appointments, manage an individual adjuster, manage reports, or manage imported claims. To enter a new claim the claim data may either be entered manually or may be imported from a CSV file. The claim details interface 4400 shown in FIG. 44 provides a user with the ability to enter data about a specific claim. The entered claim data may then be submitted for routing and scheduling. A user may also input claim data for multiple claims before submitting the claims for routing.

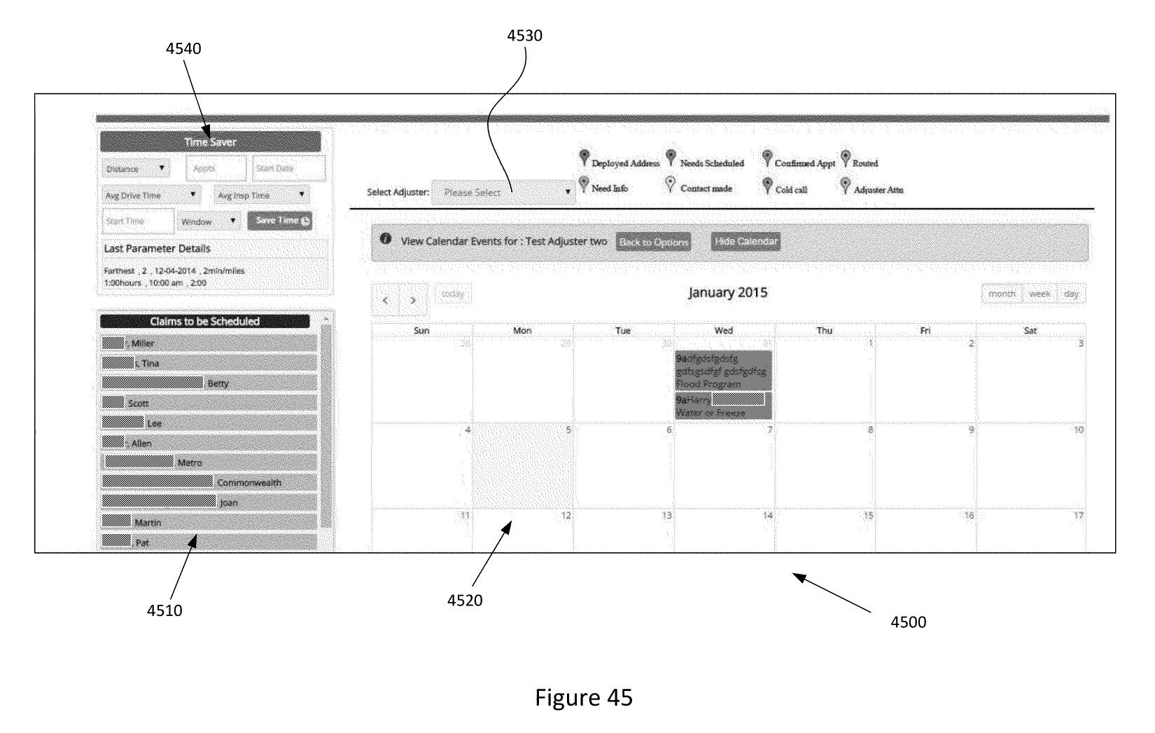

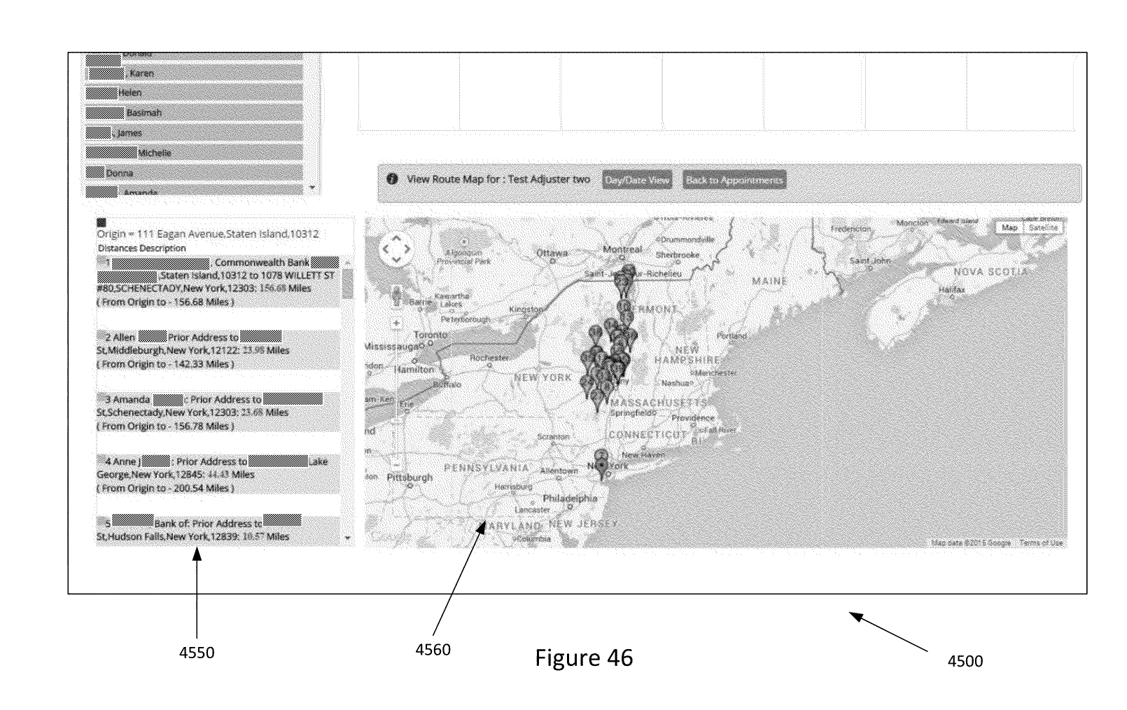

The scheduling interface 4500 shown in FIG. 45 provides a user with the ability to view claims to be scheduled 4510, view scheduled claims 4520, change parameters 4540, and select the adjuster to be scheduled for using the selection box 4530. Any claims entered into the system can be seen under claims to be scheduled 4510. The claims to be scheduled 4510 may display each insured's name or may display other information about each claim. To schedule a claim, parameters 4540 may be applied or a date/time may be applied. Select an adjuster 4530 allows a scheduler to switch back and forth between calendars for multiple insurance adjusters. Claims can be routed based on the parameters 4540 selected by the user or they may be manually routed. The parameters may include distance, number of appointments per day, start date for scheduling, start time for scheduling, average desired drive time, average desired inspection time, and appointment time window. These parameters are selected by the user and then the system places the claim on the calendar with a status of routed based on these scheduling parameters. The scheduled claims show up on the calendar 4520. The map 4560 shown in the portion of the scheduling interface 4500 in FIG. 46 displays all scheduled claims for a selected time period. Routing information for each claim appointment shown in the scheduled claims list 4550 may be viewed by selecting a single scheduled claim from the scheduled claims list 4550. Selecting a claim may also show that claim on the map 4560 and display additional information about the claim. The scheduled claims list 4550 displays the claims scheduled for a particular day or selected time period. The order of the claims in the list 4550 may be changed manually if desired by the user. Claims may also be rescheduled or re-routed as necessary if claim appointments are cancelled by the insured or by the claims adjuster. The map 4560 may also provide information on food and lodging along or near any planned routes.

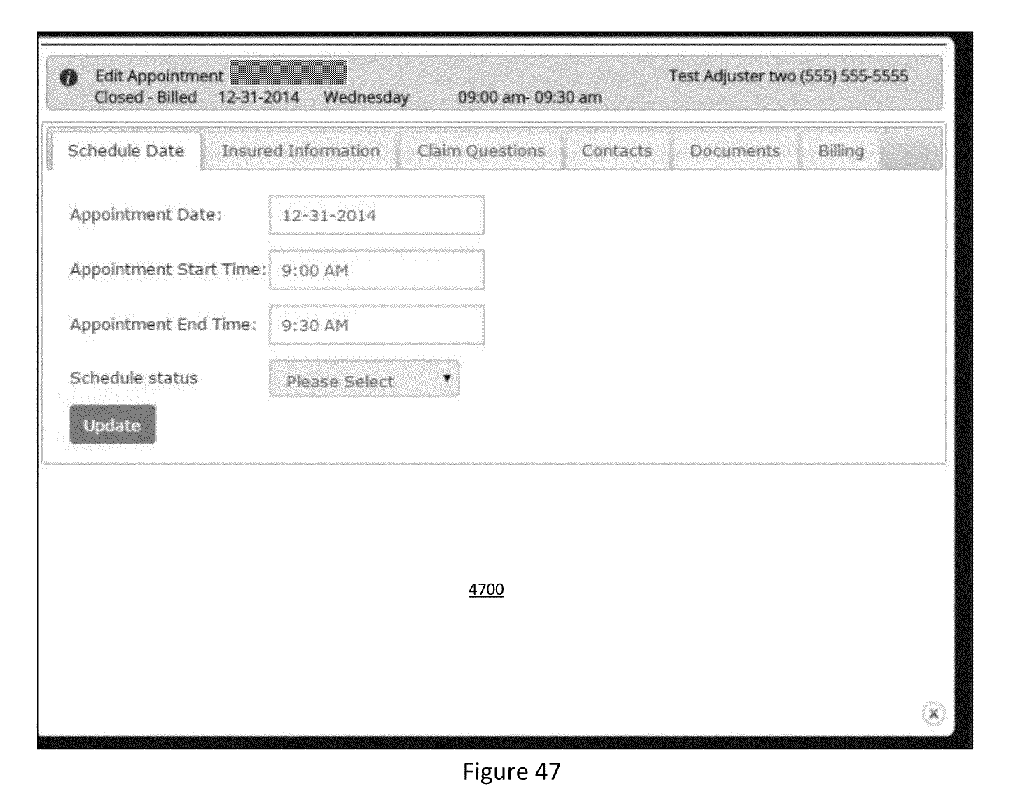

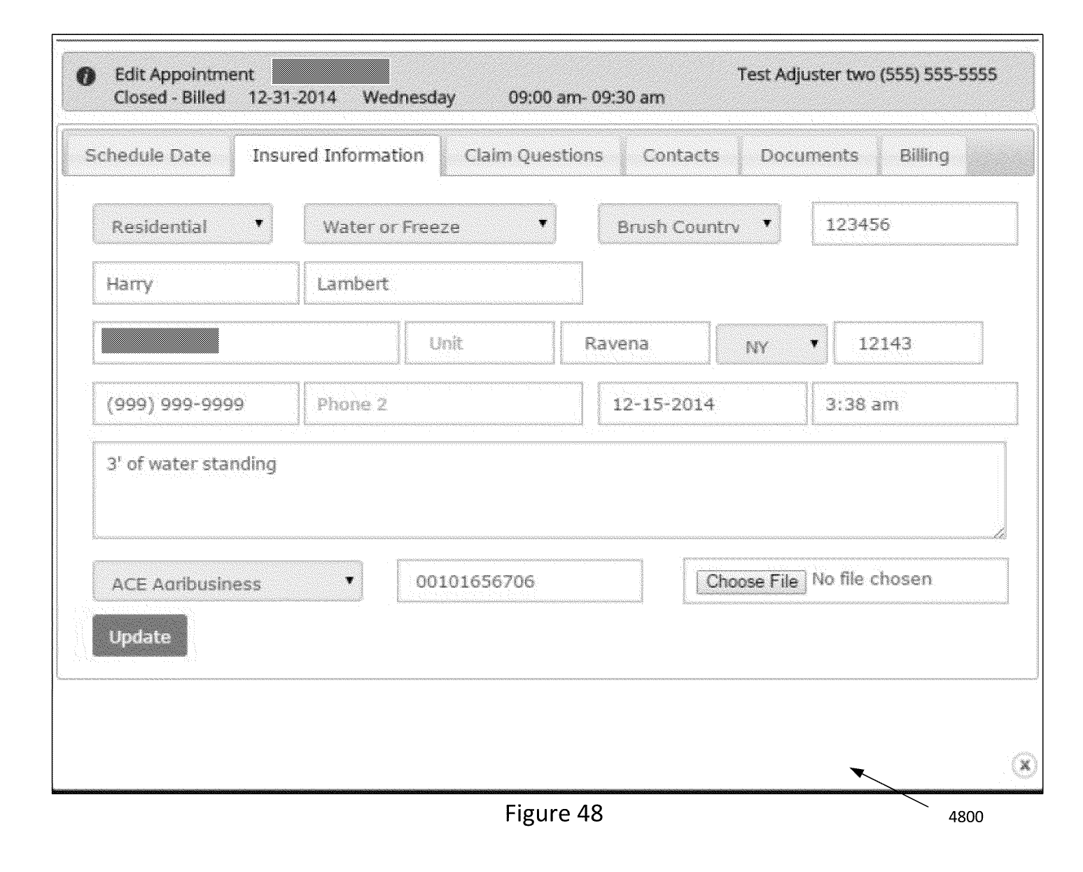

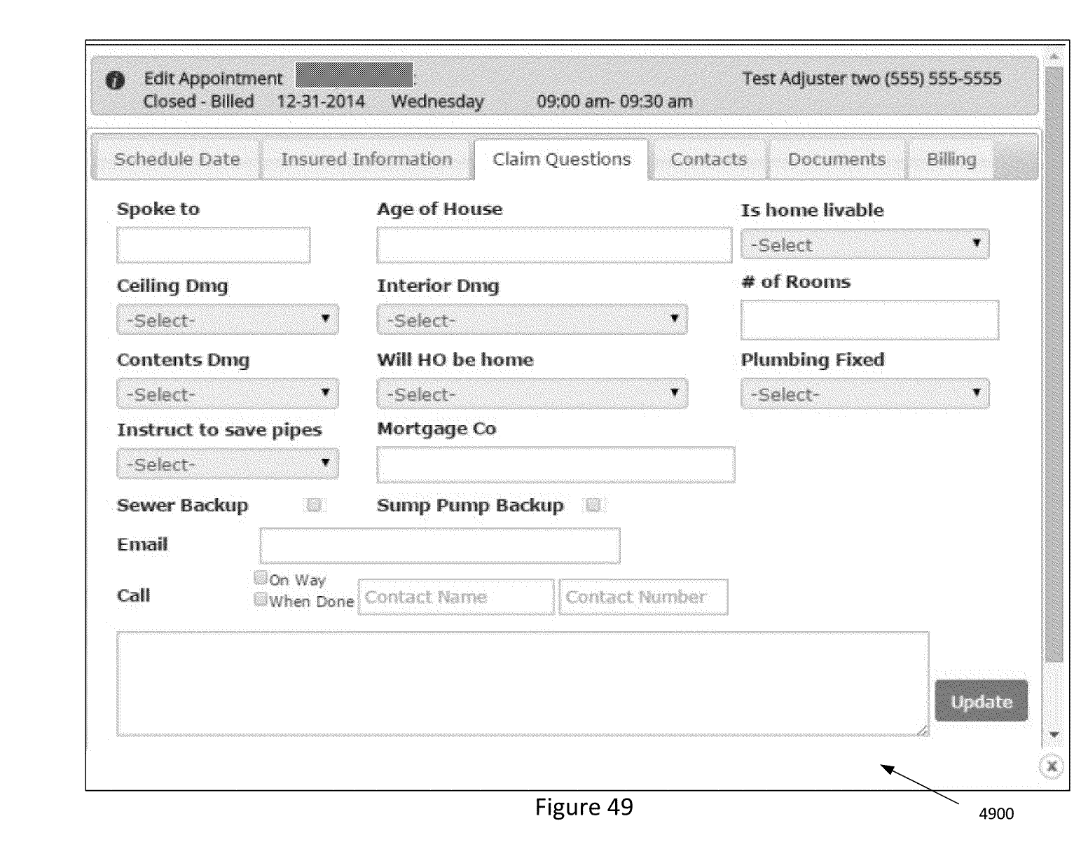

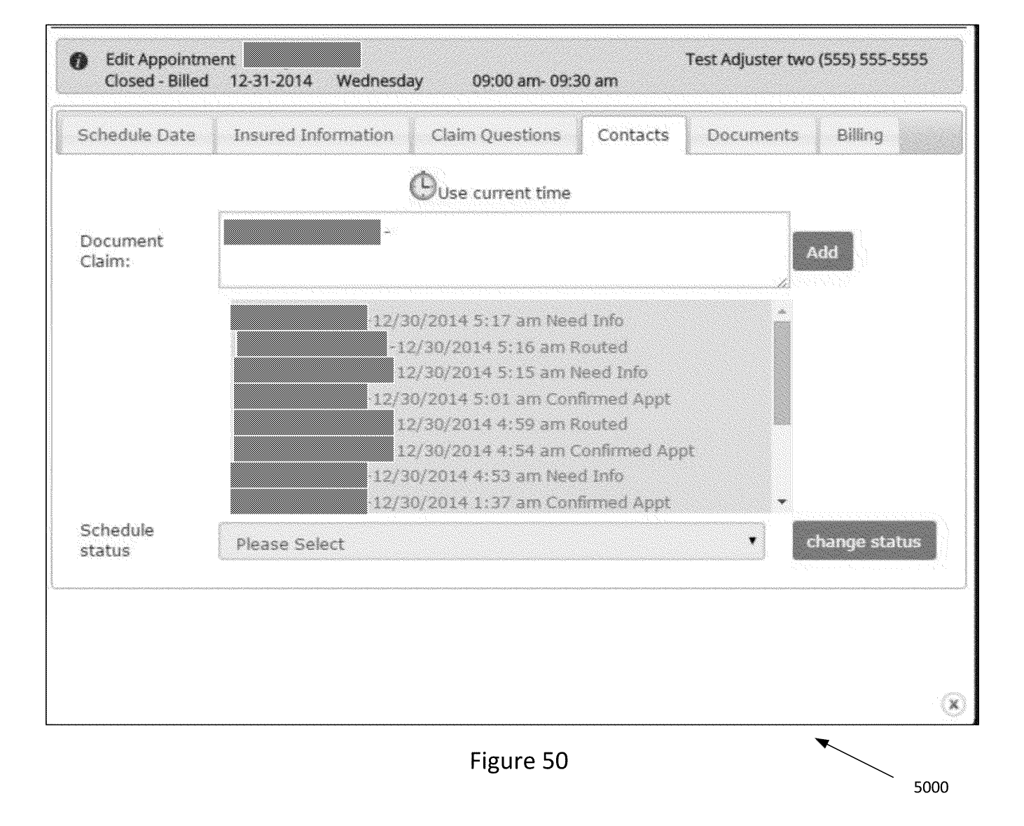

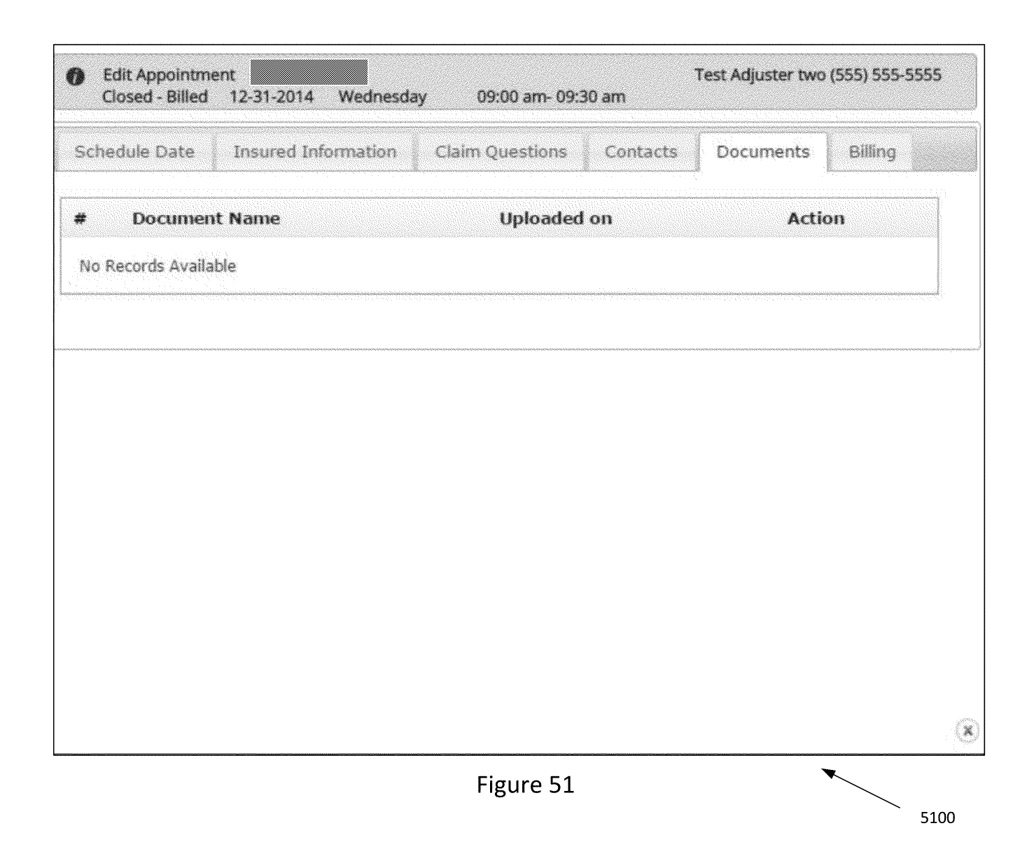

With reference now to FIGS. 47-51, screenshots of embodiments of an appointment editing interface are provided. Appointments may need to be changed or modified after initially entered into the system. The date, time and status of an appointment may be modified using the schedule date interface 4700. The insured's information may be modified using the insured information interface 4800. Information pertaining to the claim itself, e.g., comments about the insured or claim, claim damage type, home information, may be modified or added using the claim questions interface 4900. The contacts interface 4900 may also be used to log the details of any calls or communications regarding the claim being edited. The documents interface 5100 is used to view and manage any documents associated with the claim being edited.

The system according to the present invention may send out information in emails to the insured regarding a claim. The emails may comprise information on filling out various types of forms related to the claim or may comprise the forms themselves. The data stored in the system may also be modified or converted such that it may be exported into another type of claims management system.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1) A method for scheduling and managing insurance loss events, the method comprising:
a) creating a first entity record associated with a first entity and a second entity record associated with a second entity;
b) within one or both of the first entity record and the second entity record associating the first entity with the second entity;
c) associating a set of scheduling rules with the second entity;
d) generating an appointment record comprising a set of appointment information and a set of claim information, and associating the appointment record, the set of appointment information, and the set of claim information with a third entity;
e) associating the appointment record with the second entity;
f) automatically generating by a computer a set of scheduling information, the set of scheduling information based on the set of scheduling rules associated with the second entity and the appointment information and associating the set of scheduling information with the appointment record;
g) automatically generating by a computer a set of routing information based on the set of scheduling information and a set of routing preferences; and
h) generating a signal for displaying information comprising the appointment record on a display associated with the first entity or the second entity.

2) The method of claim 1 wherein the set of routing preferences comprise appointment duration, number of appointments per day, and appointment start time.

3) The method of claim 1 wherein the information comprising the appointment record is displayed on a map and on a calendar on a display associated with the first entity or the second entity.

4) The method of claim 1 further comprising associating a set of billing information and a set of expense information with the appointment record.

5) The method of claim 1 wherein the appointment information comprises claim type, insurance company information, house information, damage information, mortgage company information, and availability information.

6) The method of claim 5 wherein the claim type is selected from the group consisting of hail, wind, tornado, fire, smoke, water, freeze, flood, commercial, or hurricane.

7) The method of claim 1 wherein the appointment record is associated with the second entity by the first entity.

8) The method of claim 1 wherein the method further comprises:
a) generating a second appointment record comprising a second set of appointment information and a second set of claim information, and associating the second appointment record, the second set of appointment information, and the second set of claim information with a fourth entity;
b) associating the appointment record with the second entity;
c) automatically generating by a computer a second set of scheduling information, the second set of scheduling information based on the set of scheduling rules associated with the second entity and the appointment information and associating the second set of scheduling information with the second appointment record;
d) wherein the automatically generating by a computer a set of routing information comprises generating the set of routing information based on the set of scheduling information, the second set of scheduling information, and a set of routing preferences; and
e) wherein the generating a signal for displaying information further comprises generating a signal for displaying information comprising both the appointment record and the second appointment record on a display associated with the first entity or the second entity

9) A system for scheduling and managing insurance loss events, the system comprising:
a) an appointment database and an entity database;
b) a server, the server comprising a processor and memory, the memory adapted to store a set of instruction for execution by the processor, the instructions adapted to:
i) receive a first set of information associated with a first entity and a second set of information associated with a second entity;
ii) generate a first entity record based on the first set of information and associated with the first entity and generate a second entity record based on the second set of information and associated with the second entity;
iii) store the first entity record and second entity record in the entity database;
iv) associate the first entity record with the second entity record;
v) associate a set of rules with the second entity;
vi) generate an appointment record comprising a set of appointment information and a set of claim information, and associating the appointment record, the set of appointment information, and the set of claim information with a third entity record associated with a third entity;
vii) store the appointment record in the appointment database and the third entity record in the entity database;
viii) automatically generate a set of scheduling information, the set of scheduling information based on the set of scheduling rules associated with the second entity and the appointment information, and associate the set of scheduling information with the appointment record;
ix) automatically generate a set of routing information based on the set of scheduling information and a set of routing preferences;
x) store the set of scheduling information and routing information in the appointment database; and
xi) generate a signal for displaying the set of scheduling and routing information.

10) The system of claim 9 wherein the set of routing preferences comprise appointment duration, number of appointments per day, and appointment start time.

11) The system of claim 9 wherein the instructions are further adapted to display the appointment record on a map and on a calendar.

12) The system of claim 9 wherein the instructions are further adapted to associate a set of billing information and a set of expense information with the appointment record.

13) The system of claim 9 wherein the appointment information comprises information selected from the group consisting of claim type, insurance company information, house information, damage information, mortgage company information, and availability information.

14) The system of claim 13 wherein the claim type is selected from the group consisting of hail, wind, tornado, fire, smoke, water, freeze, flood, commercial, or hurricane.

15) The system of claim 9 wherein the instructions are further adapted to:
a) generate a second appointment record comprising a second set of appointment information and a second set of claim information, and associating the second appointment record, the second set of appointment information, and the second set of claim information with a fourth entity record associated with a fourth entity;
b) store the second appointment record in the appointment database and the fourth entity record in the entity database;
c) automatically generate a second set of scheduling information, the second set of scheduling information based on the set of scheduling rules associated with the second entity and the appointment information, and associate the second set of scheduling information with the second appointment record; and
d) automatically generate a set of routing information based on the set of scheduling information, the second set of scheduling information, and a set of routing preferences.
